(19) United States
(12) Patent Application Publication
(10) Pub. No.: US 2016/0128810 A1
(43) Pub. Date: May 12, 2016

(54) GUIDED SINUS LIFT

(71) Applicant: MAXILLENT LTD., Herzliya (IL)

(72) Inventors: Gideon FOSTICK, Givat Shmuel (IL); Ilan UCHITEL, Kfar Saba (IL); Hadar BETTER, Tel Aviv (IL); Yossi GROSS, Moshav Mazor (IL)

(73) Assignee: MAXILLENT LTD., Herzliya (IL)

(21) Appl. No.: 14/897,433

(22) PCT Filed: Jun. 12, 2014
(86) PCT No.: PCT/IB2014/062168

§ 371 Date: Dec. 10, 2015

Related U.S. Application Data
(60) Provisional application No. 61/833,976, filed on Jun. 12, 2013.

(51) Int. Cl. A61C 8/00; A61C 19/04; G06F 19/00; A61C 1/08

(52) U.S. Cl. CPC A61C 8/0092; A61C 1/084; A61C 19/04; G06F 19/3437

(57) ABSTRACT

A method and apparatus are herein provided, the method including: receiving a three dimensional virtual model of a maxillary alveolar bone of a patient, and a digital dental implant plan that defines a planned dental implant site of the maxillary bone; receiving a set of values consisting of predefined distances; creating a virtual model of a surgical guide stent for placement against an occlusal surface, wherein the virtual model of the surgical guide stent defines: a hole through the surgical guide stent at a site corresponding to the planned dental implant site defined in the digital dental implant plan, and an inferior surface surrounding the hole; and outputting the virtual model of the surgical guide stent in association with the one of the predefined distances.

### CROSS-REFERENCE TO RELATED APPLICATIONS

The present application is the US national stage of International Application PCT/IB2014/062168, filed Jun. 12, 2014, which claims priority from U.S. Provisional Application 61/833,976, filed Jun. 12, 2013.

### FIELD OF THE INVENTION

The present invention relates generally to dental tools and implantation methods, and specifically to minimally-invasive sinus lift tools and implantation methods.

### BACKGROUND OF THE APPLICATION

Osseointegrated dental implants are typically metallic or ceramic screws that are placed in the jawbone for supporting artificial teeth after the loss of natural teeth. Replacement of the maxillary teeth is often a challenging surgical procedure when the remaining maxillary bone has insufficient height to support the implant. One surgical technique for augmenting the maxillary bone includes injecting a regenerative material, such as autogenic, allogeneic, xenogeneic, or synthetic bone graft, into the vicinity of the maxillary bone. The regenerative material forms additional bone mass that integrates with the existing maxillary bone, providing the necessary alveolar height to support the implant.

Bone augmentation procedures are often surgically difficult to perform, and are associated with complications, including infection of the maxillary sinus. The top of the maxillary alveolar bone (ridge) forms the floor of the maxillary sinus, and is covered by a thin membrane known as the Schneiderian or subantral membrane. In one surgical procedure, known as a closed or internal sinus lift or elevation procedure, the surgeon drills a bore through the maxillary alveolar bone from the oral cavity at the desired location of the implant. The bore penetrates the bone to below the Schneiderian membrane. The surgeon injects the regenerative material through the bore to below the membrane, forming a cavity defined by the top of the bone and the bottom of the membrane, which cavity occupies a portion of the space initially occupied by the maxillary sinus.

To prevent potentially serious complications, the surgeon must be careful not to perforate the Schneiderian membrane. This is often difficult, because of the delicacy of the membrane, and the restricted access afforded by the closed approach.

### SUMMARY OF APPLICATIONS

Some applications of the present invention provided improved tools and drilling techniques for safely forming an osteotomy through an alveolar maxillary bone, such as for subsequent implantation of a dental implant.

In some applications of the present invention, a minimally-invasive closed sinus lift surgical procedure is provided for implanting a dental implant. The procedure is typically employed when a patient's alveolar maxillary bone lacks sufficient bone mass to support a conventional dental implant. Typically, the surgeon forms a preparatory osteotomy partially through the alveolar maxillary bone toward a sinus floor. The surgeon aims to extend this preparatory osteotomy to within about 1 to 2 mm from the superior surface of the maxillary bone, without traversing the maxillary bone.

At this or an earlier stage of the procedure, the surgeon places a surgical guide stent against an occlusal surface of gingiva covering the maxillary bone, an occlusal surface of the maxillary alveolar bone, or an occlusal surface of teeth near a planned dental implant site of the maxillary bone. The surgical guide stent is shaped so as to define (a) a hole therethrough at a site corresponding to the planned dental implant site, and (b) an inferior surface surrounding the hole.

The surgeon lengthens the preparatory osteotomy (i.e., bore) through the maxillary bone using a grinding drill. The grinding drill is shaped so as to define a shaft and a distal grinding surface, and typically grinds by rotating. The shaft is shaped so as to define a proximal stopper which has a distal stopper surface at a predefined distance from a distal end of the grinding drill. The surgeon inserts the grinding drill through the hole of the surgical guide stent and into the preparatory osteotomy. The surgeon advances the grinding drill through the maxillary bone in the preparatory osteotomy, such that the distal grinding surface lengthens the bore by grinding into the maxillary bone. In order to achieve the proper depth of advancement of the grinding drill, the surgeon typically ceases advancing the grinding drill when the distal stopper surface comes in contact with the inferior surface surrounding the hole of the surgical guide stent.

For some applications, the surgeon uses a grinding drill that has a proximal stopper with a distal stopper surface at a predefined distance, which predefined distance equals a sum of (i) a distance between the inferior surface surrounding the hole of the surgical stent guide and a superior surface of the maxillary bone and (ii) an over-advancement depth equal to between 0.1 and 4 mm, such as between 0.2 and 2.5 mm, e.g., 0.5 to 1.5 mm.

For some applications, a set of grinding drills is provided, and the surgeon selects the appropriate grinding drill from the set. This drill is the one which has an appropriate predefined distance, as described above, such that the distal stopper surface of the proximal stopper comes in contact with the inferior surface of the surgical guide stent at the same time as or soon after the distal grinding surface of the grinding drill reaches the Schneiderian membrane. The proximal stopper thus prevents accidental excessive overdrilling into the Schneiderian membrane. For some applications, the surgeon selects the appropriate grinding drill from the set responsively to a selection indication received from a provider of the surgical guide stent.

After drilling through the maxillary bone, the surgeon advances a dental implant into the preparatory osteotomy, such as by rotating the dental implant, until the distal end of the dental implant reaches the superior surface of the maxillary bone and the Schneiderian membrane, and then completes the sinus lift procedure.

Although the surgical guide stent is useful for controlling the depth of advancement of the grinding drill and the other tools described herein, the surgical guide stent may not always achieve the desired depth of insertion because of radioimaging, planning, design, fabrication, and/or placement and usage inaccuracies. Such inaccuracies may add up to +/−0.5-2 mm, which may be enough to either (a) puncture the Schneiderian membrane or (b) fail to traverse the maxillary bone, either of which could cause partial or complete failure of the surgical procedure. In accordance with some applications of the present invention, in order to address these inaccuracies, the surgical guide stent is designed and fabricated to deliberately result in a slight planned over-advancement of the grinding drill. As a result, if the inaccuracies cause unintended under-advancement, the distal end of the grinding drill still traverses the maxillary bone to the Schneiderian membrane. If the surgical stent guide is accurately manufactured as planned, or inaccuracies cause unintended over-advancement, the distal end of the grinding drill still does not damage the membrane because it is devoid of large cutting surfaces capable of perforating the membrane, and because the design limits the over-advancement to within a permissible extent that will not damage the membrane.

In some applications of the present invention, a dental system is provided that comprises a surgical guide stent and a set of dental osteotomes. Each osteotome is shaped so as to define a shaft and, for some applications, a distal grinding surface. The shaft has a proximal stopper, which has a distal stopper surface at a predefined distance from a distal end of the osteotome. The proximal stoppers of the osteotomes of the set are disposed such that the distal stopper surfaces are at respective, different distances from respective distal ends of the osteotomes. The surgeon uses one of the osteotomes to lengthen a preparatory osteotomy through the maxillary bone. In order to achieve the proper depth of advancement of the osteotome, the surgeon typically ceases advancing the osteotome when the distal stopper surface of the proximal stopper comes in contact with the inferior surface surrounding the hole of the surgical guide stent.

For some applications, after completing a bore through the maxillary bone, the surgeon uses a dental probing technique to ascertain whether the Schneiderian membrane is intact. Naively probing the membrane, without the use of this technique, may increase the risk of membrane perforation. Over-advancement is necessary in order to feel the elastic response of the membrane which indicates that it is intact. In addition, further over-advancement overcomes inaccuracies in stent design, manufacture, and usage, as described herein. The surgeon uses a surgical guide stent that has been placed against a selected occlusal surface, such as described hereinabove. The surgeon inserts a distal end of a dental probe through the hole of the surgical guide stent, and advances the dental probe through the maxillary bone. The surgeon typically ceases advancing the dental probe at the earlier of (a) the surgeon's sensing that the distal end of the probe comes in contact with the Schneiderian membrane, and (b) the distal stopper surface coming into contact with the inferior surface surrounding the hole of the surgical stent guide. During advancement of the probe, the surgeon senses elasticity of the membrane using the dental probe. Lack of an elastic sensation may indicate perforation of the membrane.

The techniques described herein may be practiced in combination with the techniques described in U.S. application Ser. No. 13/314,740, filed Dec. 8, 2011, which issued as U.S. Pat. No. 8,702,423, and which is assigned to the assignee of the present application and is incorporated herein by reference.

There is therefore provided, in accordance with an application of the present invention, a method including:

receiving (a) a three-dimensional virtual model of at least a maxillary alveolar bone of a patient, and (b) at least one digital dental implant plan that defines a planned dental implant site of the maxillary bone;

receiving a set of values consisting of between two and eight predefined distances;

creating a virtual model of a surgical guide stent for placement against an occlusal surface selected from the group consisting of: an occlusal surface of the maxillary bone of the patient, an occlusal surface of gingiva covering the maxillary bone, and an occlusal surface of teeth near the planned dental implant site, wherein the virtual model of the surgical guide stent defines:
a hole through the surgical guide stent at a site corresponding to the planned dental implant site defined in the digital dental implant plan, and
an inferior surface surrounding the hole, such that one of the predefined distances of the set equals a sum of (a) a modeled distance between the inferior surface and a superior surface of the maxillary bone and (b) an over-advancement depth equal to between 0.1 and 5 mm; and

outputting the virtual model of the surgical guide stent in association with the one of the predefined distances.

For some applications, the method further includes providing an indication of the one of the predefined distances.

For some applications, receiving the three-dimensional virtual model of at least the maxillary bone includes receiving a three-dimensional radiographic image of the maxillary bone, and converting the three-dimensional radiographic image to the three-dimensional virtual model of at least the maxillary bone.

For some applications, the method further includes fabricating the surgical guide stent based on the virtual model of the surgical guide stent. For some applications, the method further includes:

placing the fabricated surgical guide stent against the selected occlusal surface;

inserting, through the hole of the surgical guide stent, a distal end of a dental grinding drill, which dental grinding drill is shaped so as to define (a) a distal grinding surface and (b) a shaft that has a proximal stopper having a distal stopper surface at the one of the predefined distances from the distal end of the dental grinding drill; and

lengthening a bore through the maxillary bone using the dental grinding drill, by advancing the dental grinding drill through the maxillary bone until the distal stopper surface of the proximal stopper of the dental grinding drill comes in contact with the inferior surface surrounding the hole of the surgical guide stent.

There is further provided, in accordance with an application of the present invention, a method including:

receiving a virtual model of a surgical guide stent; and

based on the virtual model of the surgical guide stent, fabricating the surgical guide stent for placement against an occlusal surface selected from the group consisting of: an occlusal surface of the maxillary bone of the patient, an occlusal surface of gingiva covering the maxillary bone, and an occlusal surface of teeth near a planned dental implant site of the maxillary bone, which surgical guide stent is shaped so as to define (a) a hole therethrough at a site corresponding to the planned dental implant site, (b) an inferior surface surrounding the hole, wherein one of a set of predefined distances consisting of between two and eight predefined distances equals a sum of (a) a modeled distance between the inferior surface and a superior surface of the maxillary bone and (b) an over-advancement depth equal to between 0.1 and 5 mm.

For some applications, the method further includes providing an indication of the one of the predefined distances in association with the surgical guide stent.

There is still further provided, in accordance with an application of the present invention, a method including:

placing a surgical guide stent against an occlusal surface selected from the group consisting of: an occlusal surface of a maxillary alveolar bone of a patient, an occlusal surface of gingiva covering the maxillary bone, and an occlusal surface of teeth near a planned dental implant site of the maxillary bone, which surgical guide stent is shaped so as to define (a) a hole therethrough at a site corresponding to the planned dental implant site, and (b) an inferior surface surrounding the hole;

inserting, through the hole of the surgical guide stent, a distal end of a dental grinding drill, which dental grinding drill is shaped so as to define (a) a distal grinding surface and (b) a shaft that has a proximal stopper having a distal stopper surface at a predefined distance from the distal end of the dental grinding drill, which predefined distance equals a sum of (i) a distance between the inferior surface surrounding the hole and a superior surface of the maxillary bone of the patient and (ii) an over-advancement depth equal to between 0.1 and 4 mm; and

lengthening a bore through the maxillary bone using the dental grinding drill, by advancing the dental grinding drill through the maxillary bone until the distal stopper surface of the proximal stopper of the dental grinding drill comes in contact with the inferior surface surrounding the hole of the surgical guide stent.

For some applications, the distal grinding surface includes a surface selected from the group consisting of: a diamond bur, a carbide bur, a stainless steel bur, a titanium bur, a slotted surface, a roughened surface, and a surface shaped so as to define a plurality of small blades, and lengthening the bore includes lengthening the bore using the selected grinding surface.

For some applications, the dental grinding drill is further shaped so as to define a grinding protrusion that (a) is coaxial with the shaft, (b) defines the distal grinding surface, and (c) has a protrusion diameter that is less than a shaft diameter of a portion of the shaft that is proximally adjacent the grinding protrusion, such that the grinding protrusion extends distally from the portion of the shaft at an interface that defines a distal shoulder that does not define any grinding or grinding surfaces, and a length of the grinding protrusion, measured between the interface and the distal end of the dental grinding drill, is between 0.5 and 3 mm, and lengthening the bore includes lengthening the bore using the grinding protrusion.

For some applications, the distal grinding surface is shaped so as to define at least one end mill cutter surface configured to grind bone, and lengthening the bore includes lengthening the bore using the at least one end mill cutter surface.

For some applications, the dental grinding drill includes a plurality of visually-sensible fiducial designators distributed along the shaft thereof, and inserting includes measuring a depth of insertion of the dental grinding drill in the maxillary bone using the visually-sensible fiducial designators.

For some applications, the dental grinding drill is a member of a set of dental grinding drills, which are shaped so as to define (a) respective shafts that are shaped so as to define respective proximal stoppers having respective distal stopper surfaces at respective, different predefined distances from respective distal ends of the dental grinding drills, and (b) respective distal grinding surfaces, and inserting includes selecting the dental grinding drill from the set of dental grinding drills. For some applications, the set of dental grinding drills consists of between two and eight dental grinding drills. For some applications, selecting the dental grinding drill includes selecting the dental grinding drill responsively to a selection indication received from a provider of the surgical guide stent.

For some applications:

the shaft is shaped so as to define a proximal shoulder,

the distal stopper surface is one of a plurality of distal stopper surfaces,

the proximal stopper includes a set of proximal stopper skirts, which are shaped so as to define (a) respective ones of the distal stopper surfaces and (b) respective longitudinal bores through the skirts that are shaped and sized to be passable over (i) the distal end of the dental grinding drill and (ii) the shaft, until proximal surfaces of the proximal stopper skirts abut the proximal shoulder of the shaft, such that the distal stopper surfaces are at predefined, different distances from the distal end of the dental grinding drill, and

the method further includes, before inserting the dental grinding drill through the hole, passing one of the proximal stopper skirt over (a) the distal end of the dental grinding drill and (b) the shaft, until the proximal surface of the proximal stopper skirt abuts the proximal shoulder of the shaft.

For some applications, the set of proximal stopper skirts consists of between two and eight proximal stopper skirts. For some applications, passing the one of the proximal stopper skirts includes selecting the one of the proximal stopper skirts responsively to a selection indication received from a provider of the surgical guide stent.

There is additionally provided, in accordance with an application of the present invention, apparatus including:

a surgical guide stent shaped for placement against an occlusal surface selected from the group consisting of: an occlusal surface of a maxillary alveolar bone of a patient, an occlusal surface of gingiva covering the maxillary bone, and an occlusal surface of teeth near a planned dental implant site of the maxillary bone, which surgical guide stent is shaped so as to define (a) a hole therethrough at a site corresponding to the planned dental implant site, and (b) an inferior surface surrounding the hole; and

at least one dental grinding drill, which is shaped so as to define (a) a shaft that has a proximal stopper having a distal stopper surface at a predefined distance from a distal end of the dental grinding drill, which predefined distance is between 2 and 10 mm, and (b) a distal grinding surface,

the dental grinding drill is sized and shaped for distal-end-first insertion through the hole of the surgical guide stent, and

the proximal stopper is sized and shaped to limit advancement of the dental grinding drill upon contact between the distal stopper surface and the inferior surface surrounding the hole of the surgical guide stent.

For some applications, the distal grinding surface includes a surface selected from the group consisting of: a diamond bur, a carbide bur, a stainless steel bur, a titanium bur, a slotted surface, a roughened surface, and a surface shaped so as to define a plurality of small blades.

For some applications, the dental grinding drill is further shaped so as to define a grinding protrusion that (a) is coaxial with the shaft, (b) defines the distal grinding surface, and (c) has a protrusion diameter that is less than a shaft diameter of a portion of the shaft that is proximally adjacent the grinding protrusion, such that the grinding protrusion extends distally from the portion of the shaft at an interface that defines a distal shoulder that does not define any cutting or grinding surfaces, and a length of the grinding protrusion, measured between the interface and the distal end of the dental grinding drill, is between 0.5 and 3 mm.

For some applications, the distal grinding surface is shaped so as to define at least one end mill cutter surface configured to grind bone.

For some applications, the predefined distance equals a sum of (a) a distance between the inferior surface surrounding the hole of the surgical guide stent and a superior surface of the maxillary bone of the patient and (b) an over-advancement depth equal to between 0.1 and 4 mm.

For some applications, the apparatus further includes an indication of the predefined distance.

For some applications, the dental grinding drill includes a plurality of visually-sensible fiducial designators distributed along the shaft thereof.

For any of the applications described above:

the apparatus may include a set of dental grinding drills including the at least one dental grinding drill,

the dental grinding drills may be shaped so as to define (a) respective shafts that are shaped so as to define respective proximal stoppers having respective distal stopper surfaces at respective, different predefined distances from respective distal ends of the dental grinding drills, and (b) respective distal grinding surfaces,

the dental grinding drills may be sized and shaped for distal-end-first insertion through the hole of the surgical guide stent, and

the proximal stoppers may be sized and shaped to limit advancement of the dental grinding drills upon contact between the distal stopper surfaces and the inferior surface surrounding the hole of the surgical guide stent.

For some applications, the set of dental grinding drills consists of between two and eight dental grinding drills.

For any of the applications described above:

the shaft may be shaped so as to define a proximal shoulder,

the distal stopper surface may be one of a plurality of distal stopper surfaces,

the proximal stopper may include a set of proximal stopper skirts, which are shaped so as to define (a) respective ones of the distal stopper surfaces and (b) respective longitudinal bores through the skirts that are shaped and sized to be passable over (i) the distal end of the dental grinding drill and (ii) the shaft until proximal surfaces of the proximal stopper skirts abut the proximal shoulder of the shaft, such that the distal stopper surfaces are at predefined, different distances from the distal end of the dental grinding drill, and

the proximal stopper skirts may be sized and shaped to limit advancement of the dental grinding drill upon contact between the distal stopper surfaces and the inferior surface surrounding the hole of the surgical guide stent.

For some applications, the set of proximal stopper skirts consists of between two and eight proximal stopper skirts.

For any of the applications described above:

the shaft may be shaped so as to define a proximal shoulder,

the proximal stopper may include a proximal stopper skirt, which is shaped so as to define (a) the distal stopper surface and (b) a longitudinal bore through the skirt that is shaped and sized to be passable over (i) the distal end of the dental grinding drill and (ii) the shaft until a proximal surface of the proximal stopper skirt abuts the proximal shoulder of the shaft, and

the proximal stopper skirt may be sized and shaped to limit advancement of the dental grinding drill upon contact between the distal stopper surface and the inferior surface surrounding the hole of the surgical guide stent.

There is yet additionally provided, in accordance with an application of the present invention, apparatus including a set of dental grinding drills, which are shaped so as to define:

respective shafts that are shaped so as to define respective proximal stoppers having respective distal stopper surfaces at respective, different predefined distances from respective distal ends of the dental grinding drills, and

respective grinding protrusions that (a) are coaxial with the respective shafts, (b) define respective distal grinding surfaces, and (c) have respective protrusion diameters that are less than respective shaft diameters of respective portions of the respective shafts that are proximally adjacent the respective grinding protrusions, such that the grinding protrusions extend distally from the respective portions of the respective shafts at respective interfaces that define respective distal shoulders that do not define any grinding or grinding surfaces,

each of respective lengths of the grinding protrusions, measured between the respective interfaces and the respective distal ends of the dental grinding drills, is between 0.5 and 3 mm, and

each of the predefined distances is between 2 and 8 mm, and is at least 1 mm greater than the respective length of the respective grinding protrusion.

For some applications, the distal grinding surfaces include respective surfaces selected from the group consisting of: a diamond bur, a carbide bur, a stainless steel bur, a titanium bur, a slotted surface, a roughened surface, and a surface shaped so as to define a plurality of small blades.

For some applications, each of the shafts has a plurality of visually-sensible fiducial designators, at respective longitudinal locations along the shaft.

For any of the applications described above, the apparatus may further include a surgical guide stent shaped for placement against an occlusal surface selected from the group consisting of: an occlusal surface of a maxillary alveolar bone of a patient, an occlusal surface of gingiva covering the maxillary bone, and an occlusal surface of teeth near a planned dental implant site of the maxillary bone, which surgical guide stent is shaped so as to define (a) a hole therethrough at a site corresponding to the planned dental implant site, and (b) an inferior surface surrounding the hole; the dental grinding drills may be sized and shaped for distal-end-first insertion through the hole of the surgical guide stent; and the proximal stoppers may be sized and shaped to limit advancement of the dental grinding drills upon contact between the distal stopper surfaces and the inferior surface surrounding the hole of the surgical guide stent.

There is also provided, in accordance with an application of the present invention, apparatus including:

a dental grinding drill, which is shaped so as to define (a) a shaft that is shaped so as to define a proximal shoulder having a distal shoulder surface at a predefined distance from a distal end of the dental grinding drill, which predefined distance is between 2 and 10 mm, and (b) a grinding protrusion that (i) is coaxial with the shaft, (ii) defines a distal grinding surface, and (iii) has a protrusion diameters that is less than a shaft diameter of a portion of the shaft that is proximally adjacent the grinding protrusion, such that the grinding protrusion extends distally from the portion of the shaft at an interface that defines a distal shoulder that does not define any grinding or grinding surfaces, wherein a length of the grinding protrusion, measured between the interface and the distal end of the dental grinding drill, is between 0.5 and 3 mm, and is at least 1 mm less than the predefined distance; and

a set of proximal stopper skirts, which are shaped so as to define (a) respective distal stopper surfaces and (b) respective longitudinal bores through the skirts that are shaped and sized to be passable over (i) the distal end of the dental grinding drill and (ii) the shaft until proximal surfaces of the proximal stopper skirts abut the proximal shoulder of the shaft, such that the distal stopper surfaces are at predefined, different distances from the distal end of the dental grinding drill.

For some applications, the dental grinding drill includes a plurality of visually-sensible fiducial designators distributed along the shaft thereof.

There is further provided, in accordance with an application of the present invention, a method including:

placing a surgical guide stent against an occlusal surface selected from the group consisting of: an occlusal surface of a maxillary alveolar bone of a patient, an occlusal surface of gingiva covering the maxillary bone, and an occlusal surface of teeth near a planned dental implant site of the maxillary bone, which surgical guide stent is shaped so as to define (a) a hole therethrough at a site corresponding to the planned dental implant site, and (b) an inferior surface surrounding the hole;

forming an osteotomy through the maxillary bone;

inserting, through the hole of the surgical guide stent, a distal end of a dental probe, which dental probe is shaped so as to define (a) a blunt distal end and (b) a shaft that has a proximal stopper having a distal stopper surface at a predefined distance from the distal end, which predefined distance equals a sum of (i) a distance between the inferior surface surrounding the hole and a superior surface of the maxillary bone of the patient and (ii) an over-advancement depth equal to between 1 and 5 mm;

advancing the dental probe through the maxillary bone until the distal end comes in contact with a Schneiderian membrane; and

sensing elasticity of the Schneiderian membrane using the dental probe.

For some applications, the method further includes ceasing advancing if the distal stopper surface of the dental probe comes in contact with the inferior surface surrounding the hole of the surgical guide stent.

For some applications, the dental probe includes a plurality of visually-sensible fiducial designators distributed along the shaft thereof, and advancing including measuring a depth of insertion of the dental probe in the maxillary bone using the visually-sensible fiducial designators.

For some applications, the dental probe is a member of a set of dental probes, which are shaped so as to define (a) respective blunt distal ends, and (b) respective shafts that are shaped so as to define respective proximal stoppers having respective distal stopper surfaces at respective, different predefined distances from respective distal ends of the dental probes, and inserting includes selecting the dental probe from the set of dental probes. For some applications, the set of dental probes consists of between two and eight dental probes, and selecting includes selecting the dental probe from the set of dental probes consisting of between two and eight dental probes. For some applications, selecting the dental probe includes selecting the dental probe responsively to a selection indication received from a provider of the surgical guide stent.

For some applications:

the shaft is shaped so as to define a proximal shoulder,

the distal stopper surface is one of a plurality of distal stopper surfaces,

the proximal stopper includes a set of proximal stopper skirts, which are shaped so as to define (a) respective ones of the distal stopper surfaces and (b) respective longitudinal bores through the skirts that are shaped and sized to be passable over (i) the distal end of the dental probe and (ii) the shaft, until proximal surfaces of the proximal stopper skirts abut the proximal shoulder of the shaft, such that the distal stopper surfaces are at predefined, different distances from the distal end of the dental probe, and

the method further includes, before inserting the dental probe through the hole, passing one of the proximal stopper skirt over (a) the distal end of the dental probe and (b) the shaft, until the proximal surface of the proximal stopper skirt abuts the proximal shoulder of the shaft.

For some applications, the set of proximal stopper skirts consists of between two and eight proximal stopper skirts. For some applications, passing the one of the proximal stopper skirts includes selecting the one of the proximal stopper skirts responsively to a selection indication received from a provider of the surgical guide stent.

There is still further provided, in accordance with an application of the present invention, apparatus including:

a surgical guide stent shaped for placement against an occlusal surface selected from the group consisting of: an occlusal surface of a maxillary alveolar bone of a patient, an occlusal surface of gingiva covering the maxillary bone, and an occlusal surface of teeth near a planned dental implant site of the maxillary bone, which surgical guide stent is shaped so as to define (a) a hole therethrough at a site corresponding to the planned dental implant site, and (b) an inferior surface surrounding the hole; and

at least one dental probe, which is shaped so as to define (a) a blunt distal end, and (b) a shaft that has a proximal stopper having a distal stopper surface at a predefined distance from the distal end, which predefined distance is between 3 and 12 mm,

the dental probe is sized and shaped for distal-end-first insertion through the hole of the surgical guide stent, and

the proximal stopper is sized and shaped to limit advancement of the dental probe upon contact between the distal stopper surface and the inferior surface surrounding the hole of the surgical guide stent.

For some applications, the dental probe includes a plurality of visually-sensible fiducial designators distributed along the shaft thereof.

For some applications, the predefined distance equals a sum of (a) a distance between the inferior surface surrounding the hole of the surgical guide stent and a superior surface of the maxillary bone of the patient and (b) an over-advancement depth equal to between 1 and 5 mm.

For some applications, including an indication of the predefined distance.

For any of the applications described above:

the apparatus may include a set of dental probes including the at least one dental probe,

the dental probes may be shaped so as to define (a) respective blunt distal ends, and (b) respective shafts that are shaped so as to define respective proximal stoppers having respective distal stopper surfaces at respective, different predefined distances from respective distal ends of the dental probes,

the dental probes may be sized and shaped for distal-end-first insertion through the hole of the surgical guide stent, and

the proximal stoppers may be sized and shaped to limit advancement of the dental probes upon contact between the distal stopper surfaces and the inferior surface surrounding the hole of the surgical guide stent.

For some applications, the set of dental probes consists of between two and eight dental probes.

For any of the applications described above:

the shaft may be shaped so as to define a proximal shoulder,

the proximal stopper may include a proximal stopper skirt, which is shaped so as to define (a) the distal stopper surface and (b) a longitudinal bore through the skirt that is shaped and sized to be passable over (i) the distal end of the dental probe and (ii) the shaft until a proximal surface of the proximal stopper skirt abuts the proximal shoulder of the shaft, and

the proximal stopper skirt may be sized and shaped to limit advancement of the dental probe upon contact between the distal stopper surface and the inferior surface surrounding the hole of the surgical guide stent.

There is additionally provided, in accordance with an application of the present invention, a method including:

placing a surgical guide stent against an occlusal surface selected from the group consisting of: an occlusal surface of a maxillary alveolar bone of a patient, an occlusal surface of gingiva covering the maxillary bone, and an occlusal surface of teeth near a planned dental implant site of the maxillary bone, which surgical guide stent is shaped so as to define (a) a hole therethrough at a site corresponding to the planned dental implant site, and (b) an inferior surface surrounding the hole;

inserting, through the hole of the surgical guide stent, a distal end of a dental osteotome, which dental osteotome is shaped so as to define (a) a distal surface and (b) a shaft shaped so as to define a proximal stopper having a distal stopper surface at a predefined distance from the distal end of the dental osteotome, which predefined distance equals a sum of (i) a distance between the inferior surface surrounding the hole and a superior surface of the maxillary bone of the patient and (ii) an over-advancement depth equal to between 0.1 and 4 mm; and

lengthening a bore through the maxillary bone using the dental osteotome, by advancing the dental osteotome through the maxillary bone until the distal stopper surface of the proximal stopper of the dental osteotome comes in contact with the inferior surface surrounding the hole of the surgical guide stent.

For some applications, the dental osteotome includes a rotational dental osteotome, and lengthening the bore includes rotating the rotational dental osteotome to lengthen the bore. For some applications, the distal surface includes a distal grinding surface, and lengthening the bore includes rotating the distal grinding surface to length the bore. For some applications, the distal grinding surface includes a surface selected from the group consisting of: a diamond bur, a carbide bur, a stainless steel bur, a titanium bur, a slotted surface, a roughened surface, and a surface shaped so as to define a plurality of small blades, and lengthening the bore includes lengthening the bore using the selected grinding surface.

For some applications, the rotational dental osteotome is further shaped so as to define a grinding protrusion that (a) is coaxial with the shaft, (b) defines the distal grinding surface, and (c) has a protrusion diameter that is less than a shaft diameter of a portion of the shaft that is proximally adjacent the grinding protrusion, such that the grinding protrusion extends distally from the portion of the shaft at an interface that defines a distal shoulder that does not define any grinding or grinding surfaces, and a length of the grinding protrusion, measured between the interface and the distal end of the dental grinding drill, is between 0.5 and 3 mm; and lengthening the bore includes lengthening the bore using the grinding protrusion.

For some applications, the distal grinding surface is shaped so as to define at least one end mill cutter surface configured to grind bone, and lengthening the bore includes lengthening the bore using the at least one end mill cutter surface.

For some applications, the distal surface is shaped so as to define a distal cutting surface, and lengthening the bore includes lengthening the bore by cutting using the distal cutting surface.

For some applications, the distal cutting surfaces are shaped so as to define respective cracking tips, and lengthening the bore includes lengthening the bore by cracking bone of the maxillary bone.

For some applications, the dental osteotome includes an impact dental osteotome, and lengthening the bore includes applying a longitudinal impact to the impact dental osteotome.

For some applications, the dental osteotome includes a plurality of visually-sensible fiducial designators distributed along the shaft thereof, and inserting includes measuring a depth of insertion of the dental osteotome in the maxillary bone using the visually-sensible fiducial designators.

For some applications, the dental osteotome is a member of a set of dental osteotomes, which are shaped so as to define (a) respective shafts that are shaped so as to define respective proximal stoppers having respective distal stopper surfaces at respective, different predefined distances from respective distal ends of the dental osteotomes, and (b) respective distal surfaces; and inserting includes selecting the dental osteotome from the set of dental osteotomes. For some applications, the set of dental osteotomes consists of between two and eight dental osteotomes. For some applications, selecting the dental osteotome includes selecting the dental osteotome responsively to a selection indication received from a provider of the surgical guide stent.

For some applications:

the shaft is shaped so as to define a proximal shoulder,

the distal stopper surface is one of a plurality of distal stopper surfaces,

the proximal stopper includes a set of proximal stopper skirts, which are shaped so as to define (a) respective ones of the distal stopper surfaces and (b) respective longitudinal bores through the skirts that are shaped and sized to be passable over (i) the distal end of the dental osteotome and (ii) the shaft, until proximal surfaces of the proximal stopper skirts abut the proximal shoulder of the shaft, such that the distal stopper surfaces are at predefined, different distances from the distal end of the dental osteotome, and

the method further includes, before inserting the dental osteotome through the hole, passing one of the proximal stopper skirt over (a) the distal end of the dental osteotome and (b) the shaft, until the proximal surface of the proximal stopper skirt abuts the proximal shoulder of the shaft.

For some applications, the set of proximal stopper skirts consists of between two and eight proximal stopper skirts. For some applications, passing the one of the proximal stopper skirts includes selecting the one of the proximal stopper skirts responsively to a selection indication received from a provider of the surgical guide stent.

For some applications, the hole of the surgical guide stent is shaped so as to define an internal thread, and the dental osteotome is shaped so as to define an outer surface, a portion of which is shaped so as to define an external thread that is configured to engage the internal thread of the hole.

For some applications, the osteotome is shaped so as to define a lumen therethrough, having a distal end that opens through at least one distal opening on a distal end of the osteotome, and a proximal end that opens through a proximal opening on a proximal end of the osteotome; and the method further includes injecting a fluid into the proximal end of the lumen, through the lumen, and out of the distal end of the lumen.

There is yet additionally provided, in accordance with an application of the present invention, apparatus including:

a surgical guide stent shaped for placement against an occlusal surface selected from the group consisting of: an occlusal surface of a maxillary alveolar bone of a patient, an occlusal surface of gingiva covering the maxillary bone, and an occlusal surface of teeth near a planned dental implant site of the maxillary bone, which surgical guide stent is shaped so as to define (a) a hole therethrough at a site corresponding to the planned dental implant site, and (b) an inferior surface surrounding the hole; and

at least one dental osteotome, which is shaped so as to define (a) a shaft that has a proximal stopper having a distal stopper surface at a predefined distance from a distal end of the dental osteotome, which predefined distance is between 2 and 10 mm, and (b) a distal surface,

the dental osteotome is sized and shaped for distal-end-first insertion through the hole of the surgical guide stent, and

the proximal stopper is sized and shaped to limit advancement of the dental osteotome upon contact between the distal stopper surface and the inferior surface surrounding the hole of the surgical guide stent.

For some applications, the dental osteotome includes a rotational dental osteotome, which is configured such that rotation thereof lengthens a bore in the maxillary alveolar bone. For some applications, the distal surface includes a distal grinding surface. For some applications, the distal grinding surface includes a surface selected from the group consisting of: a diamond bur, a carbide bur, a stainless steel bur, a titanium bur, a slotted surface, a roughened surface, and a surface shaped so as to define a plurality of small blades. For some applications, the dental osteotome is further shaped so as to define a grinding protrusion that (a) is coaxial with the shaft, (b) defines the distal grinding surface, and (c) has a protrusion diameter that is less than a shaft diameter of a portion of the shaft that is proximally adjacent the grinding protrusion, such that the grinding protrusion extends distally from the portion of the shaft at an interface that defines a distal shoulder that does not define any cutting or grinding surfaces, and a length of the grinding protrusion, measured between the interface and the distal end of the dental osteotome, is between 0.5 and 3 mm. For some applications, the distal grinding surface is shaped so as to define at least one end mill cutter surface configured to grind bone.

For some applications, the distal surface is shaped so as to define a distal cutting surface. For some applications, the distal cutting surfaces are shaped so as to define respective cracking tips.

For some applications, the dental osteotome includes an impact dental osteotome.

For some applications, the predefined distance equals a sum of (a) a distance between the inferior surface surrounding the hole of the surgical guide stent and a superior surface of the maxillary bone of the patient and (b) an over-advancement depth equal to between 0.1 and 4 mm.

For some applications, the apparatus further includes an indication of the predefined distance.

For some applications, the dental osteotome includes a plurality of visually-sensible fiducial designators distributed along the shaft thereof.

For any of the applications described above:

the apparatus may include a set of dental osteotomes including the at least one dental osteotome,

the dental osteotomes may be shaped so as to define (a) respective shafts that are shaped so as to define respective proximal stoppers having respective distal stopper surfaces at respective, different predefined distances from respective distal ends of the dental osteotomes, and (b) respective distal surfaces,

the dental osteotomes may be sized and shaped for distal-end-first insertion through the hole of the surgical guide stent, and

the proximal stoppers may be sized and shaped to limit advancement of the dental osteotomes upon contact between the distal stopper surfaces and the inferior surface surrounding the hole of the surgical guide stent.

For some applications, the set of dental osteotomes consists of between two and eight dental osteotomes.

For any of the applications described above:

the shaft may be shaped so as to define a proximal shoulder,

the distal stopper surface may be one of a plurality of distal stopper surfaces,

the proximal stopper may include a set of proximal stopper skirts, which are shaped so as to define (a) respective ones of the distal stopper surfaces and (b) respective longitudinal bores through the skirts that are shaped and sized to be passable over (i) the distal end of the dental osteotome and (ii) the shaft until proximal surfaces of the proximal stopper skirts abut the proximal shoulder of the shaft, such that the distal stopper surfaces are at predefined, different distances from the distal end of the dental osteotome, and

the proximal stopper skirts may be sized and shaped to limit advancement of the dental osteotome upon contact between the distal stopper surfaces and the inferior surface surrounding the hole of the surgical guide stent.

For some applications, the set of proximal stopper skirts consists of between two and eight proximal stopper skirts.

For any of the applications described above:

the shaft may be shaped so as to define a proximal shoulder,

the proximal stopper may include a proximal stopper skirt, which is shaped so as to define (a) the distal stopper surface and (b) a longitudinal bore through the skirt that is shaped and sized to be passable over (i) the distal end of the dental osteotome and (ii) the shaft until a proximal surface of the proximal stopper skirt abuts the proximal shoulder of the shaft, and

the proximal stopper skirt may be sized and shaped to limit advancement of the dental osteotome upon contact between the distal stopper surface and the inferior surface surrounding the hole of the surgical guide stent.

There is also provided, in accordance with an application of the present invention, apparatus including a set of dental osteotomes, which are shaped so as to define:

respective shafts that are shaped so as to define respective proximal stoppers having respective distal stopper surfaces at respective, different predefined distances from respective distal ends of the dental osteotomes, and

respective grinding protrusions that (a) are coaxial with the respective shafts, (b) define respective distal grinding surfaces, and (c) have respective protrusion diameters that are less than respective shaft diameters of respective portions of the respective shafts that are proximally adjacent the respective grinding protrusions, such that the grinding protrusions extend distally from the respective portions of the respective shafts at respective interfaces that define respective distal shoulders that do not define any grinding or grinding surfaces,

each of respective lengths of the grinding protrusions, measured between the respective interfaces and the respective distal ends of the dental osteotomes, is between 0.5 and 3 mm, and

each of the predefined distances is between 2 and 8 mm, and is at least 1 mm greater than the respective length of the respective grinding protrusion.

For some applications, the distal grinding surfaces include respective surfaces selected from the group consisting of: a diamond bur, a carbide bur, a stainless steel bur, a titanium bur, a slotted surface, a roughened surface, and a surface shaped so as to define a plurality of small blades.

For some applications, each of the shafts has a plurality of visually-sensible fiducial designators, at respective longitudinal locations along the shaft.

For any of the applications described above, the apparatus may further include a surgical guide stent shaped for placement against an occlusal surface selected from the group consisting of: an occlusal surface of a maxillary alveolar bone of a patient, an occlusal surface of gingiva covering the maxillary bone, and an occlusal surface of teeth near a planned dental implant site of the maxillary bone, which surgical guide stent is shaped so as to define (a) a hole therethrough at a site corresponding to the planned dental implant site, and (b) an inferior surface surrounding the hole; the dental osteotomes may be sized and shaped for distal-end-first insertion through the hole of the surgical guide stent; and the proximal stoppers may be sized and shaped to limit advancement of the dental osteotomes upon contact between the distal stopper surfaces and the inferior surface surrounding the hole of the surgical guide stent.

There is further provided, in accordance with an application of the present invention, apparatus including:

a dental osteotome, which is shaped so as to define (a) a shaft that is shaped so as to define a proximal shoulder having a distal shoulder surface at a predefined distance from a distal end of the dental osteotome, which predefined distance is between 2 and 10 mm, and (b) a grinding protrusion that (i) is coaxial with the shaft, (ii) defines a distal grinding surface, and (iii) has a protrusion diameters that is less than a shaft diameter of a portion of the shaft that is proximally adjacent the grinding protrusion, such that the grinding protrusion extends distally from the portion of the shaft at an interface that defines a distal shoulder that does not define any grinding or grinding surfaces, and a length of the grinding protrusion, measured between the interface and the distal end of the dental osteotome, is between 0.5 and 3 mm, and is at least 1 mm less than the predefined distance; and

a set of proximal stopper skirts, which are shaped so as to define (a) respective distal stopper surfaces and (b) respective longitudinal bores through the skirts that are shaped and sized to be passable over (i) the distal end of the dental osteotome and (ii) the shaft until proximal surfaces of the proximal stopper skirts abut the proximal shoulder of the shaft, such that the distal stopper surfaces are at predefined, different distances from the distal end of the dental osteotome.

For some applications, the dental osteotome includes a plurality of visually-sensible fiducial designators distributed along the shaft thereof.

The present invention will be more fully understood from the following detailed description of applications thereof, taken together with the drawings, in which:

### BRIEF DESCRIPTION OF THE DRAWINGS

FIG. 1 is a schematic illustration of a set of dental tools, in accordance with an application of the present invention;

FIG. 2 is a schematic illustration of a set of dental drills, in accordance with an application of the present invention;

FIG. 3 is a schematic illustration of a dental grinding drill, in accordance with an application of the present invent;

FIGS. 4A-B are schematic illustrations of a distal portion of the grinding drill of FIG. 3, in accordance with respective applications of the present invention;

FIG. 5 is a schematic illustration of a set of dental grinding drills, in accordance with an application of the present invention;

FIG. 6 is a schematic illustration of a set of dental probes, in accordance with an application of the present invention;

FIGS. 7A-B are schematic illustrations of a single grinding drill and a set of proximal stopper skirts, in accordance with an application of the present invention;

FIGS. 8A-B are schematic illustrations of a single dental probe and a set of proximal stopper skirts, in accordance with an application of the present invention;

FIGS. 9A-J are schematic illustrations of several steps of a minimally-invasive stent-assisted closed sinus lift surgical procedure for implanting a dental implant, in accordance with an application of the present invention;

FIG. 10 is a schematic illustration of a dental system, in accordance with an application of the present invention;

FIGS. 11A-B are schematic illustrations of the use of the dental system of FIG. 10, in accordance with an application of the present invention;

FIG. 12 is a schematic illustration of a dental probing technique, in accordance with an application of the present invention;

FIGS. 13 and 14A-C are schematic illustrations of techniques for advancing a grinding drill a desired distance through a maxillary bone, in accordance with an application of the present invention;

FIG. 15 is a flowchart schematically illustrating a method for fabricating a surgical guide stent, in accordance with an application of the present invention;

FIG. 16 is a schematic illustration of a surgical guide stent applied to an occlusal surface of teeth near a planned dental implant site of a maxillary bone, in accordance with an application of the present invention; and

FIG. 17 is a schematic illustration of a step of a minimally-invasive stent-assisted closed sinus lift surgical procedure, in accordance with an application of the present invention.

### DETAILED DESCRIPTION OF APPLICATIONS

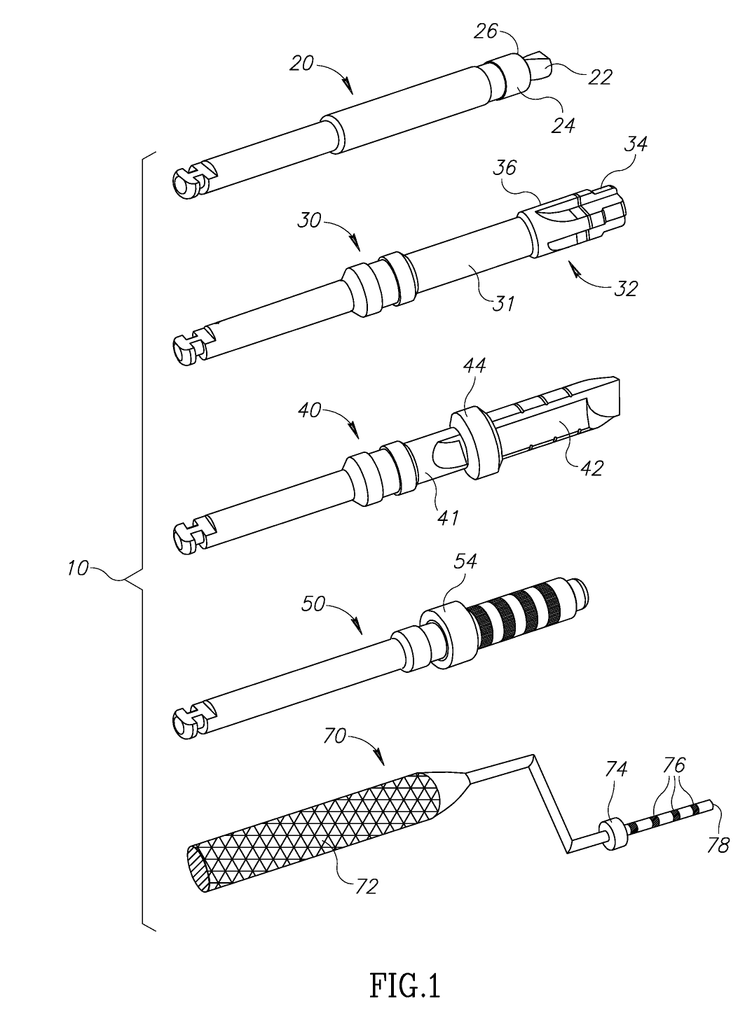

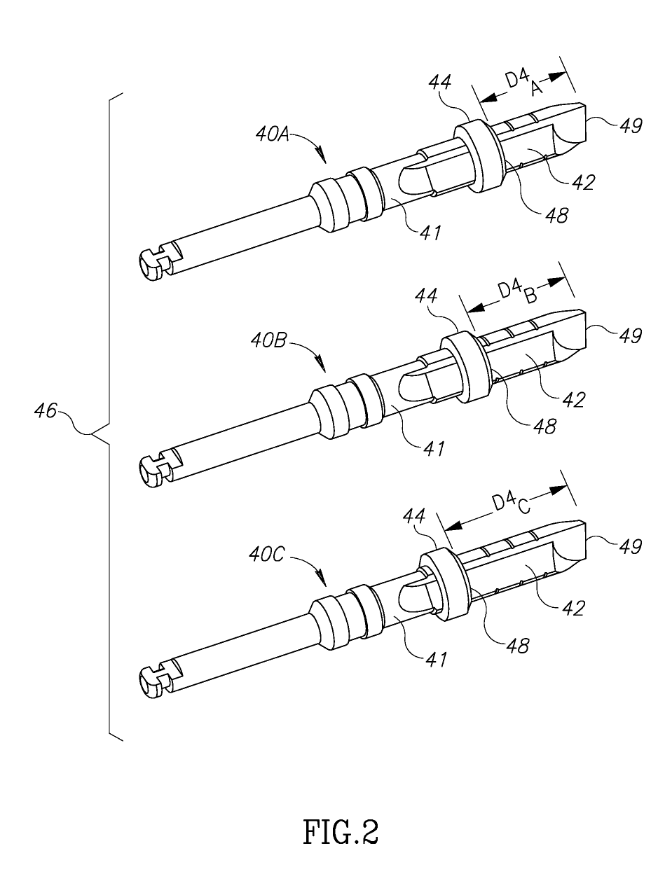

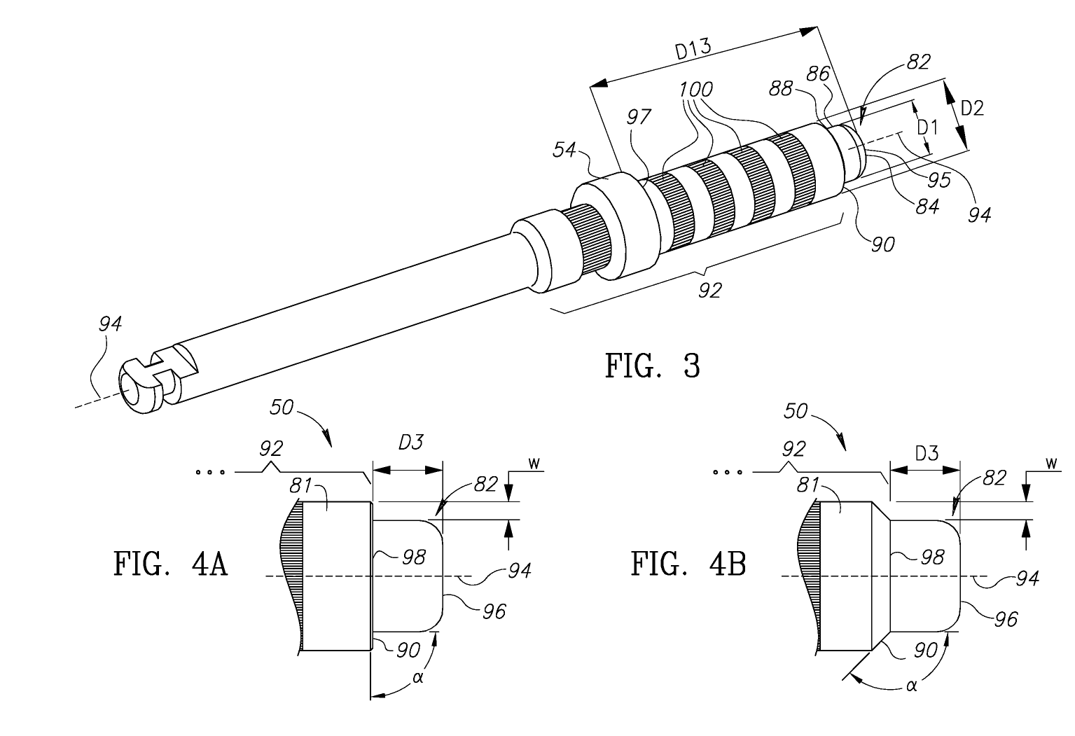

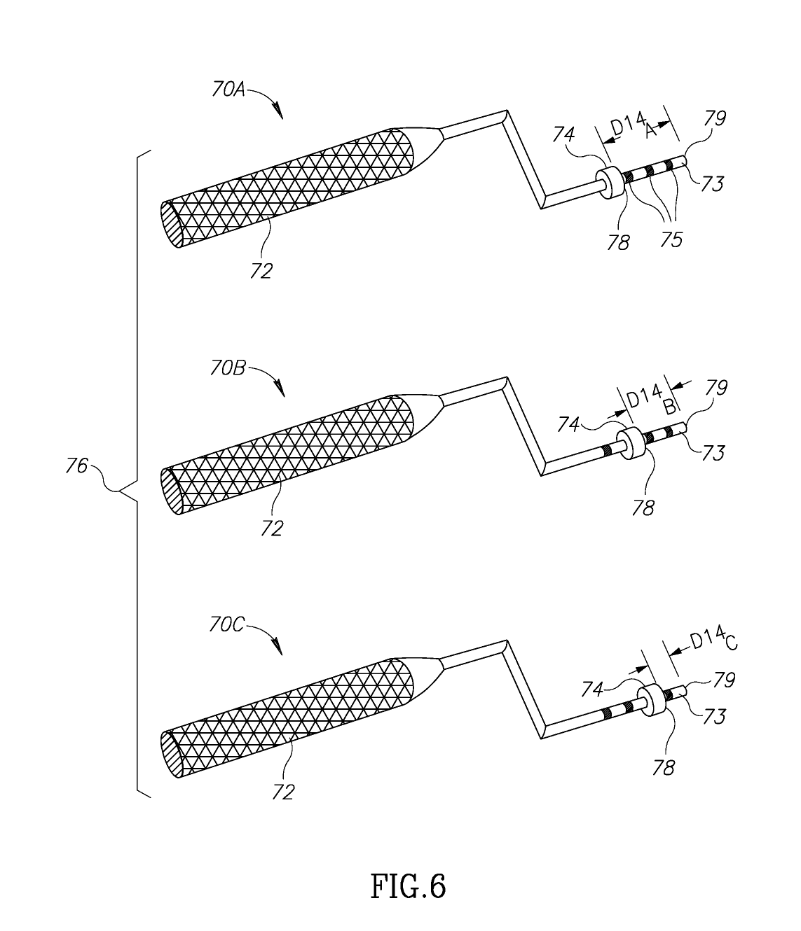

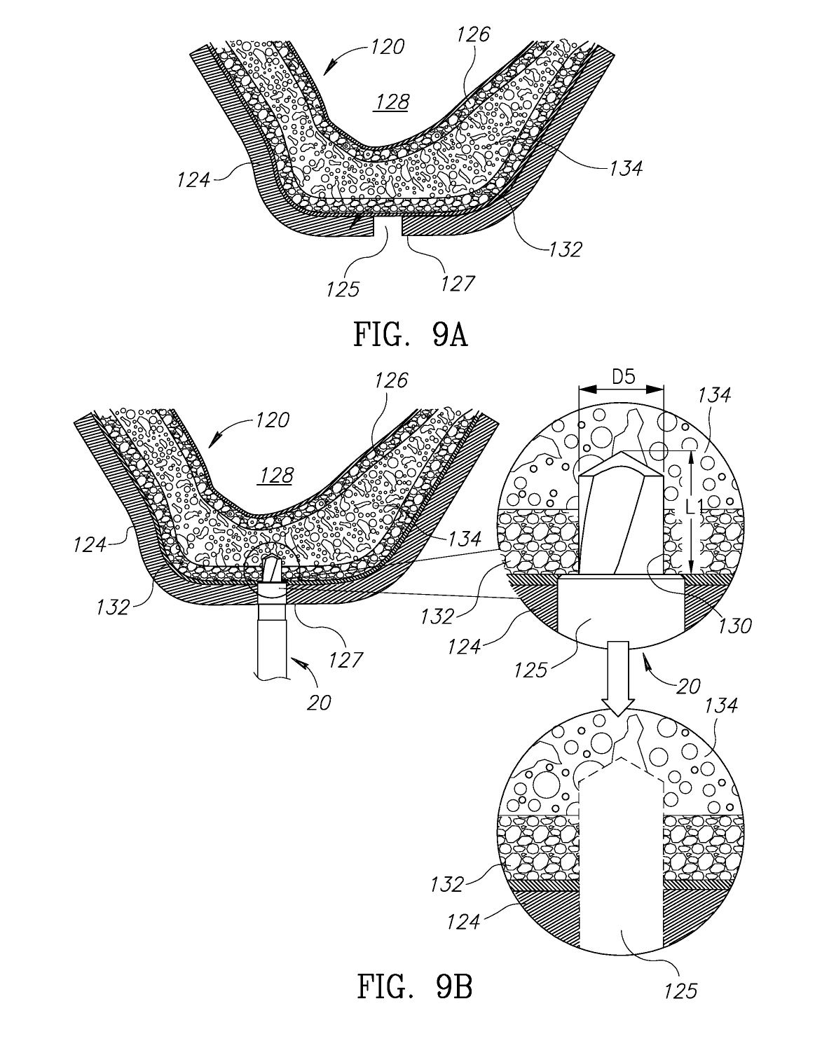

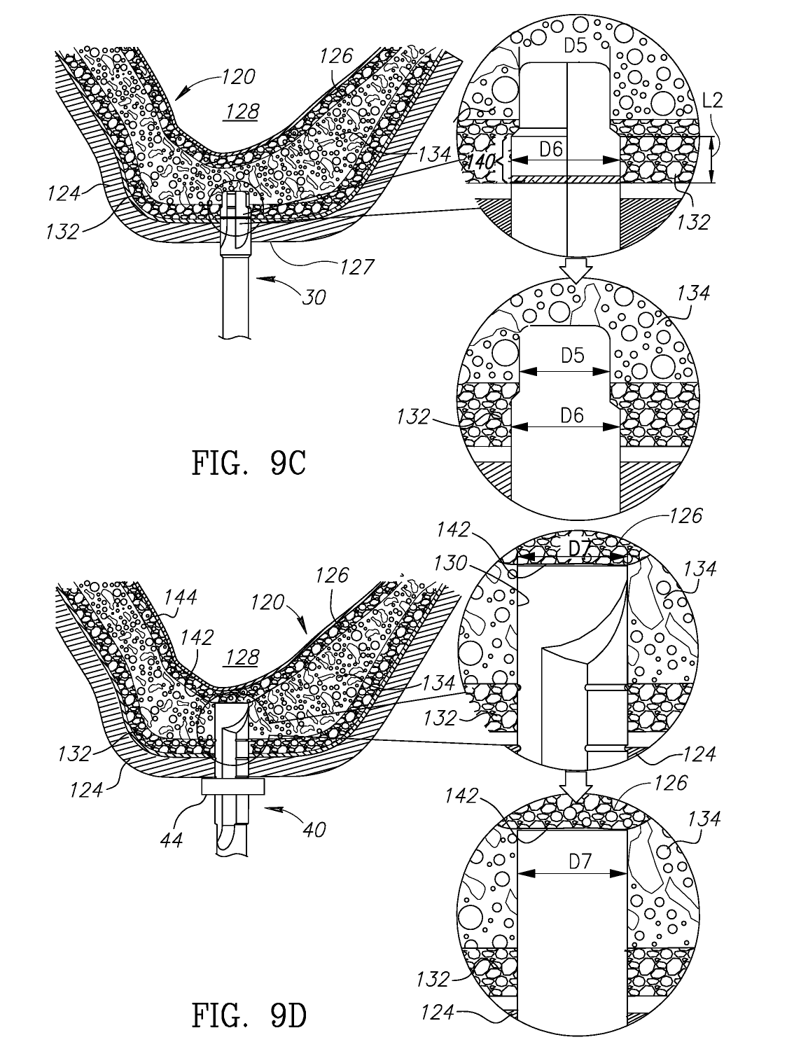

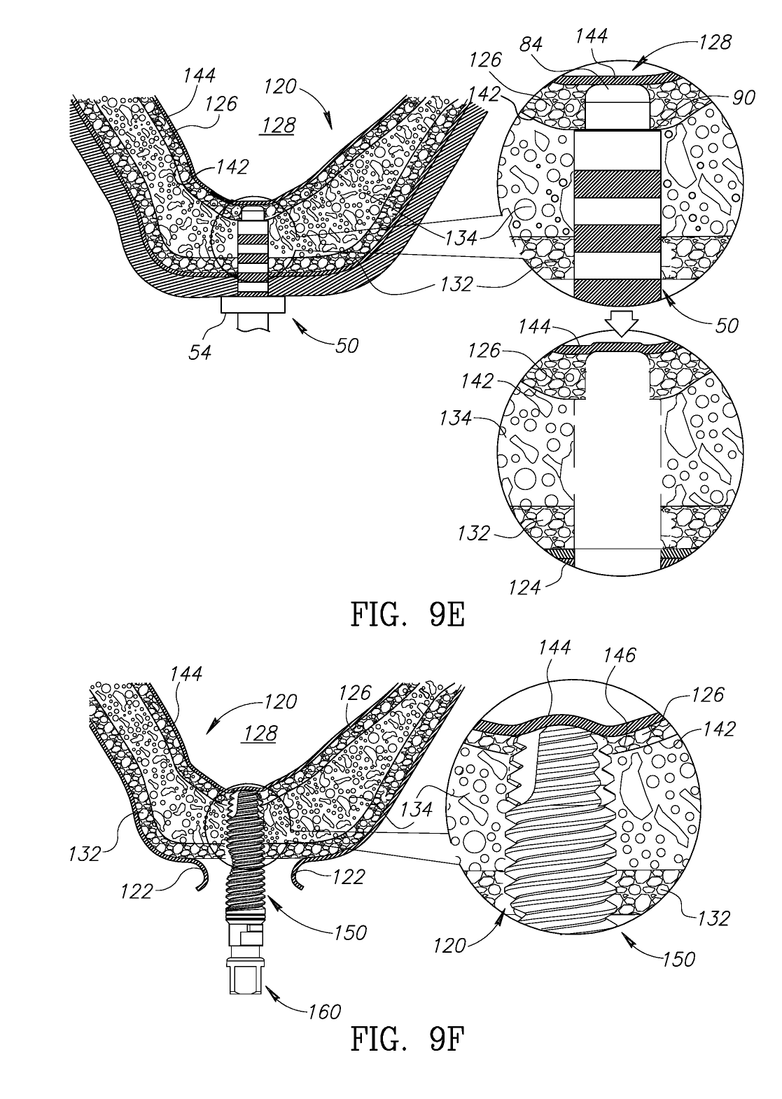

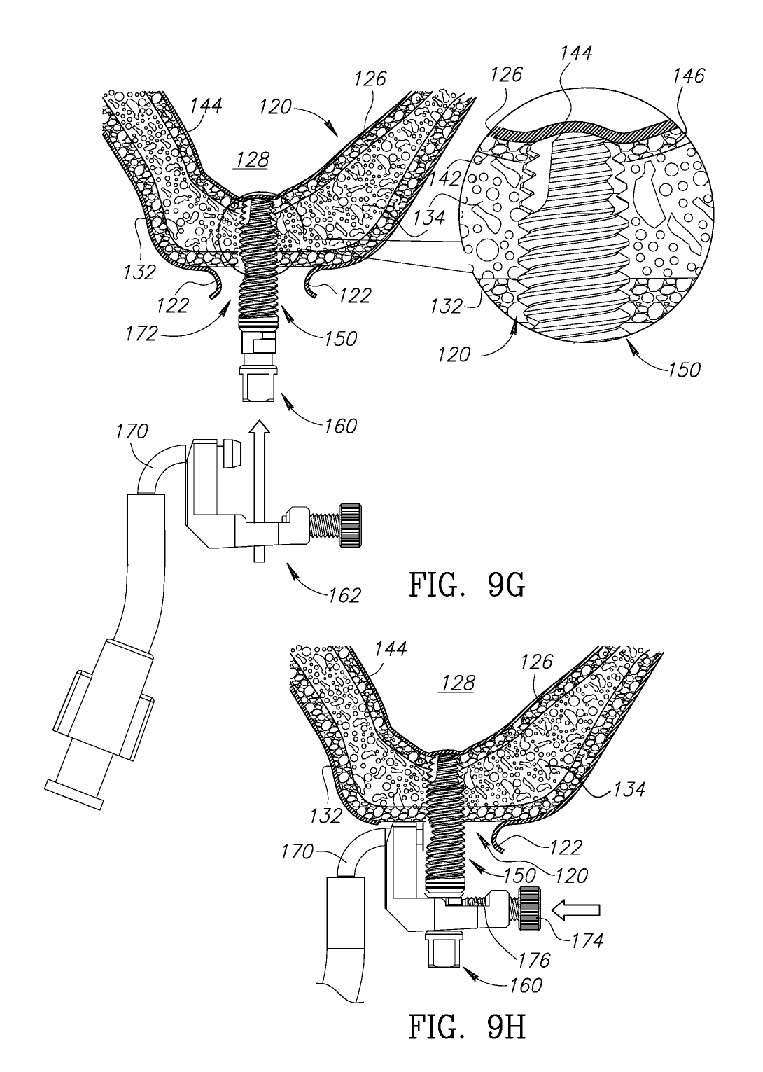

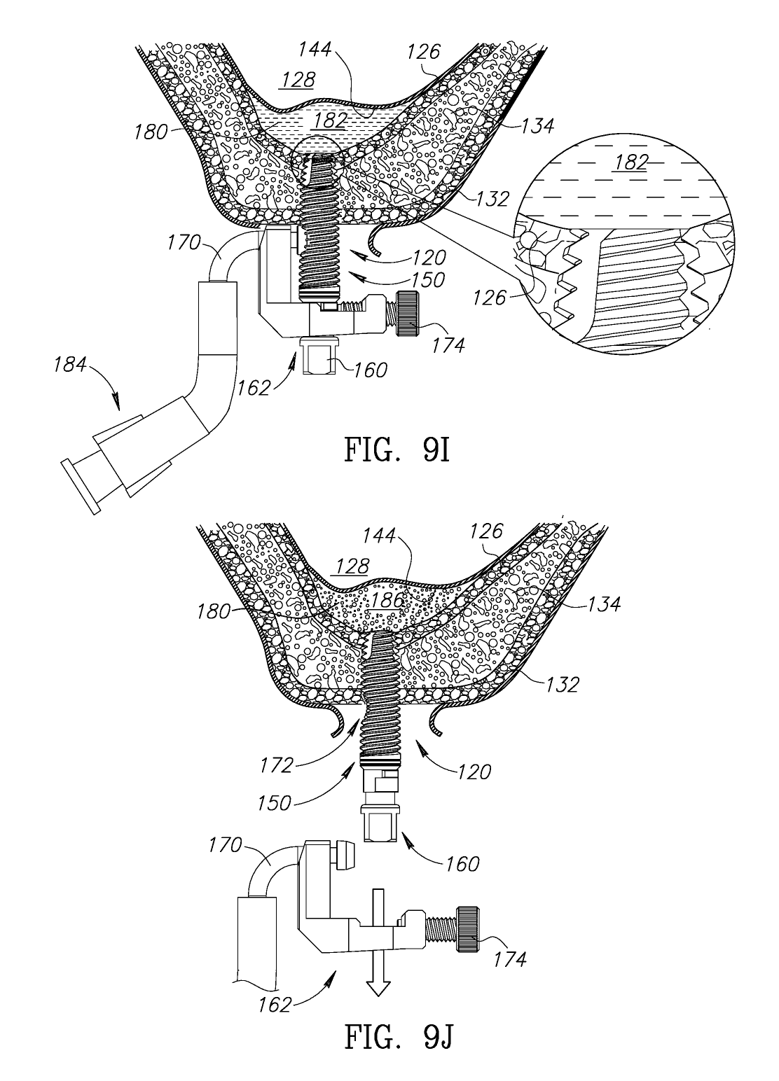

FIG. 1 is a schematic illustration of a set 10 of dental tools, in accordance with an application of the present invention. Set 10 or a subset thereof may be used to perform the dental procedures described herein, and/or to perform other dental procedures. Set 10 may include one or more of the following dental tools:
a pilot drill 20, which typically comprises a dental twist drill shaped so as to define a stopper 24. Pilot drill 20 is shaped so as to define a proximal shaft 21, a distal bur 22, and stopper 24 proximal to bur 22. Stopper 24 has a greater diameter than that of bur 22, and defines a shoulder 26 comprising a non-cutting distal surface, which prevents advancement of pilot drill 20 beyond a depth equal to a length of bur 22. Typically, bur 22 has a length of between 2 and 5, such as 3 mm;
a counterbore drill 30, which is shaped so as to define a proximal shaft 31 and a distal bur 32. Distal bur 32 includes distal and proximal portions 34 and 36. Proximal portion 36 is shaped so as to define a cutting surface. A diameter of proximal portion 36 is greater than that of distal portion 34.
a drill 40, which is shaped so as to define a shaft 41, a distal cutting edge 42, and, optionally, a proximal stopper 44, as described hereinbelow with reference to FIG. 2. Drill 40 is sized and shaped for distal-end-first insertion through hole 125 of surgical guide stent 124, as described hereinbelow with reference to FIG. 9D;
a grinding drill 50, which is described in detail hereinbelow with reference to FIGS. 3, 4A-B, and 5; and/or
a dental probe 70, which is described hereinbelow with reference to FIG. 6.

The proximal ends of the above-mentioned drills typically have an interface to a dental handpiece (such as a physiodispenser) or a high-speed dental power drill. Optionally, the drills may be irrigated, either externally and/or internally. The drills may have depth markings (e.g., laser-etched).

Reference is made to FIG. 2, which is a schematic illustration of a set 46 of dental drills 40, in accordance with an application of the present invention. As described above, each drill 40 is shaped so as to define shaft 41 and distal cutting edge 42, which may be flat. Optionally, shaft 41 has, e.g., is shaped so as to define, proximal stopper 44. Proximal stopper 44 has a distal stopper surface 48 at a predefined distance D4 from a distal end 49 of drill 40. Proximal stoppers 44 of drills 40 of set 46 are disposed such that distal stopper surfaces 48 are at respective, different distances D4 from respective distal ends 49. By way of example and not limitation, set 46 is shown consisting of three dental drills 40A, 40B, and 40C, having distal stopper surfaces at distances D4_{A}, D4_{B}, and D4_{C}, respectively, from respective distal ends 49. Typically, set 46 consists of between two and eight dental drills 40, such as four dental drills. Typically, each of distances D4 is at least 1 mm, no more than 9 mm, and/or between 1 and 9 mm, such as at least 2 mm, no more than 7 mm, and/or between 2 and 7 mm.

Reference is made to FIG. 3, which is a schematic illustration of grinding drill 50, in accordance with an application of the present invention. Grinding drill 50 is shaped so as to define a shaft 81 and a distal grinding surface 84 (i.e., an abrasive surface). Typically, distal grinding surface 84 is devoid of large cutting surfaces (and optionally may have a generally blunt outer contour) and includes a portion perpendicular to a central longitudinal axis 94 of grinding drill 50, which portion is generally flat or convexly curved. For some applications, the distal grinding surface includes a surface selected from the group consisting of: a diamond bur (e.g., comprising embedded diamond particles), a carbide bur (e.g., having a fine mesh of cutting edges, for example crisscrossed), a stainless steel bur, a titanium bur, a slotted surface, a roughened surface, and a surface shaped so as to define a plurality of small blades (e.g., each protruding less than 1 mm from the distal surface). Alternatively, for some applications, the distal grinding surface comprises at least one end mill cutter surface configured to grind bone. Grinding drill 50 is sized and shaped for distal-end-first insertion through hole 125 of surgical guide stent 124, as described hereinbelow with reference to FIG. 9E.

Typically, grinding drill 50 grinds by rotating. Alternatively, the drill grinds by moving in a reciprocating motion (back and forth), which may reduce the already low risk of damaging the Schneiderian membrane if the tip of the drill should come into contact with the membrane, as described hereinbelow. Further alternatively, distal grinding surface 84 utilizes non-mechanical means for grinding, such as ultrasound energy, typically generated using one or more piezoelectric transducers.

Shaft 81 typically is shaped so as to define a proximal stopper 54 which has a distal stopper surface 97 at a predefined distance D13 from a distal end 95 of grinding drill 50. Distance D13 is typically at least 2 mm, no more than 10 mm, and/or between 2 and 10 mm, such as at least 3 mm, no more than 8 mm, and/or between 3 and 8 mm.

Optionally, for some applications, grinding drill 50 is further shaped so as to define a grinding protrusion 82. Grinding protrusion 82 defines at least distal grinding surface 84, and, optionally, a lateral grinding surface 86. Grinding protrusion 82 is coaxial with and extends distally from shaft 81 at an interface 88 that defines a distal shoulder 90. Distal shoulder 90 does not define a grinding surface, such that the distal shoulder is not configured to cut into cortical bone. The distal shoulder thus is configured to stop advancement of the drill when the distal shoulder comes in contact with cortical bone, such as described hereinbelow with FIG. 9E. Alternatively or additionally, the distal shoulder slows advancement of the drill, thereby allowing easy control of advancement depth of the drill, optionally in conjunction with the use of visually-sensible fiducial designators 100, described hereinbelow. Grinding protrusion 82 has a diameter D1 less than a diameter D2 of a portion 92 of shaft 81 that is proximally adjacent grinding protrusion 82. For example, D1 may be between 1.5 and 4 mm, such as 2.4 or 2.8 mm, and D2 may be between 2 and 6 mm, such as 3.2 or 3.65 mm.

Reference is still made to FIG. 3. For some applications, portion 92 of shaft 81 has a plurality of visually-sensible fiducial designators 100 distributed therealong at respective longitudinal locations along portion 92, e.g., at one-millimeter intervals. The dental surgeon may use designators 100 to visually gauge a depth of insertion of the drill in an osteotomy.

For some applications, grinding drill 50 is irrigated, either externally and/or internally. Internal irrigation may decrease the likelihood of damaging the Schneiderian membrane.

Reference is made to FIGS. 4A-B, which are schematic illustrations of a distal portion of grinding drill 50, in accordance with respective applications of the present invention. Typically distal shoulder 90 has a width W, measured radially outward from central longitudinal axis 94 of portion 92 of shaft 81, of at least 0.2 mm, no more than 3 mm, and/or between 0.2 and 3 mm, such as 0.4 mm. A distal-most portion 96 of grinding protrusion 82 extends a distance D3 distally beyond a distal end 98 of shaft 81. For example, distance D3 may be at least 0.5 mm, such as at least 1 mm, e.g., 1.5 mm, and/or no more than 3 mm, e.g., between 0.5 and 3 mm. Typically, distal-most portion 96 includes a radially-central point of grinding protrusion 82. For some applications, as shown in FIGS. 4A-B, the surface of distal shoulder 90 is generally flat, while for other applications, the surface of distal shoulder 90 is curved (configuration not shown).

For some applications, central longitudinal axis 94 and a line defined by a surface of distal shoulder 90 define an angle α (alpha) therebetween, measured on a distal side of the line, which angle is between 85 and 135 degrees, such as between 85 and 95 degrees, e.g., 90 degrees. In the configuration shown in FIG. 4A (and FIGS. 1, 3, and 9E), angle α (alpha) equals 90 degrees. In the configuration shown in FIG. 4B, angle α (alpha) equals about 130 degrees.

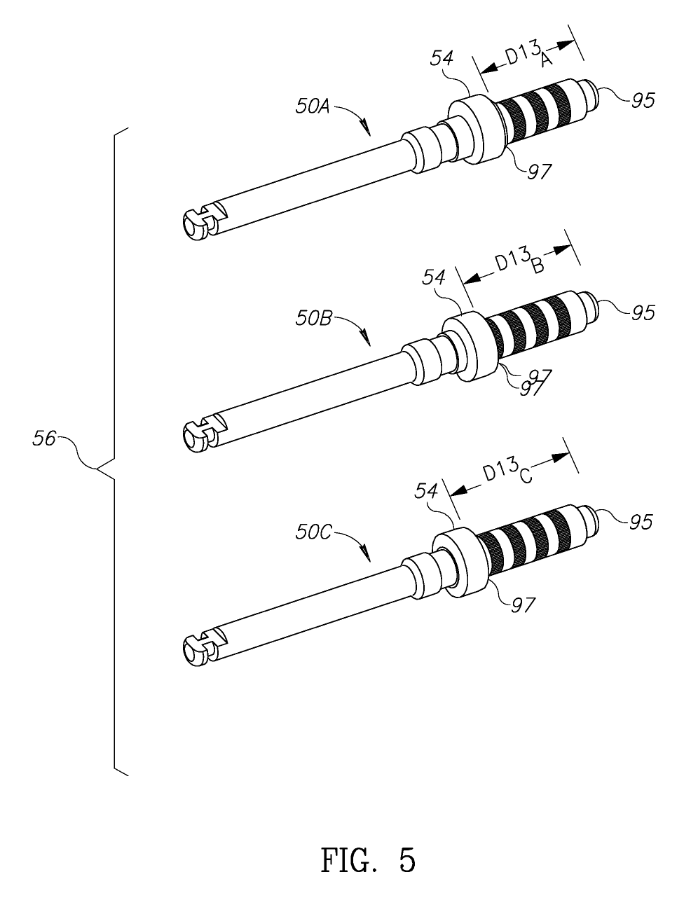

Reference is made to FIG. 5, which is a schematic illustration of a set 56 of dental grinding drills 50, in accordance with an application of the present invention. Proximal stoppers 54 of grinding drills 50 of set 56 are disposed such that distal stopper surfaces 97 are at respective, different distances D13 from respective distal ends 95. By way of example and not limitation, set 56 is shown consisting of three grinding drills 50A, 50B, and 50C, having distal stopper surfaces at distances D13_{A}, D13_{B}, and D13_{C}, respectively, from respective distal ends 95. Typically, set 56 consists of between two and eight grinding drills 50, such as four grinding drills.

Reference is made to FIG. 6, which is a schematic illustration of a set 76 of dental probes 70, in accordance with an application of the present invention. Each probe 70 is shaped so as to define a proximal handle 72, a shaft 73, and a blunt distal end 79, which optionally is rounded. Optionally, shaft 73 has, e.g., is shaped so as to define, a proximal stopper 74. Proximal stopper 74 has a distal stopper surface 78 at a predefined distance D14 from distal end 79 of probe 70. Proximal stoppers 74 of probes 70 of set 76 are disposed such that distal stopper surfaces 78 are at respective, different distances D14 from respective distal ends 79. By way of example and not limitation, set 76 is shown consisting of three dental probes 70A, 70B, and 70C, having distal stopper surfaces at distances D14_{A}, D14_{B}, and D14_{C}, respectively, from respective distal ends 79. Typically, set 76 consists of between two and eight dental probes 70, such as four dental probes. Typically, each of distances D4 is at least 3 mm, no more than 12 mm, and/or between 3 and 12 mm, such as at least 4 mm, no more than 9 mm, and/or between 4 and 9 mm.

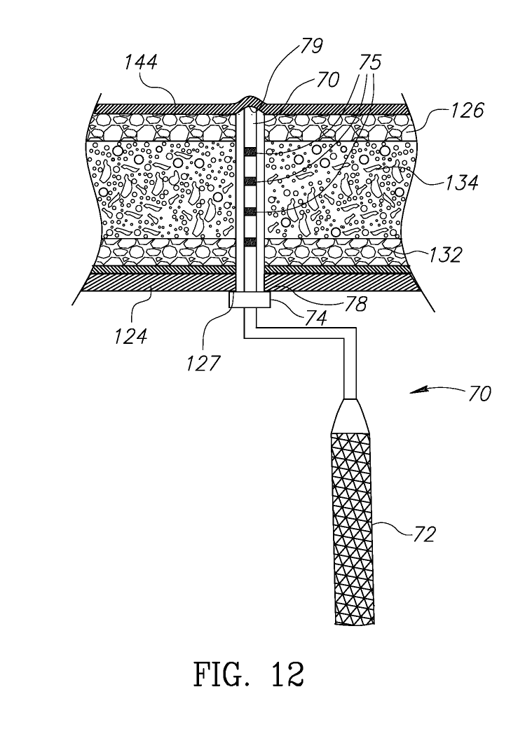

For some applications, shaft 73 has a plurality of visually-sensible fiducial designators 75 distributed therealong at respective longitudinal locations therealong, e.g., at one-millimeter intervals. The dental surgeon may use designators 75 to visually gauge a depth of insertion of dental probe 70 in an osteotomy, such as described hereinbelow with reference to FIG. 12.

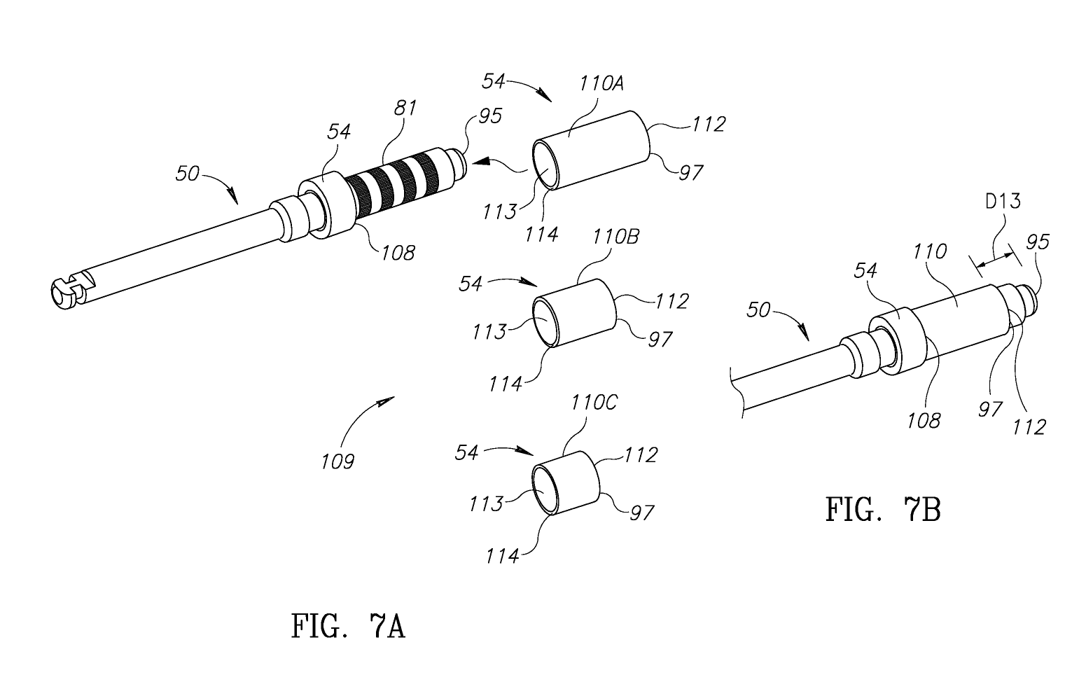

Reference is now made to FIGS. 7A-B, which are schematic illustrations of a single grinding drill 50 and a set 109 of proximal stopper skirts 110, in accordance with an application of the present invention. In this configuration, shaft 81 of grinding drill 50 is shaped so as to define a proximal shoulder 108. Proximal stoppers 54 comprise proximal stopper skirts 110, respectively, which have respective, different longitudinal lengths. For some applications, as shown in FIGS. 7A-B, external surfaces of proximal stopper skirts 110 are cylindrical.

Respective distal ends 112 of proximal stopper skirts 110 are shaped so as to define respective ones of distal stopper surfaces 97. Proximal stopper skirts 110 are further shaped so as to define respective longitudinal bores 113 therethrough that are shaped and sized to be passable over (a) distal end 95 of grinding drill 50 and (b) shaft 81 of grinding drill 50, until proximal surfaces 114 of proximal stopper skirts 110 abut proximal shoulder 108 of shaft 81, such that distal stopper surfaces 97 are at the predefined, different distances D13 from distal end 95 of dental grinding drill 50. The skirts thus reduce the effective length of grinding drill 50 by the length of the selected skirt.

By way of example and not limitation, set 109 is shown consisting of three proximal stopper skirts 110A, 110B, and 110C. Typically, set 109 consists of between two and eight proximal stopper skirts 110, such as four proximal stopper skirts. Typically, each of the proximal stopper skirts has a longitudinal length of at least 2 mm, no more than 9 mm, and/or between 2 and 9 mm, and typically proximal shoulder 108 is positioned at a distance of at least 3 mm, no more than 10 mm, and/or between 3 and 10 mm from distal end 95 of grinding drill 50, such that a difference between (a) the length of each of the skirts and (b) the distance between proximal shoulder 108 and distal end 95 is at least 2 mm, no more than 10 mm, and/or between 2 and 10 mm, such as at least 3 mm, no more than 8 mm, and/or between 3 and 8 mm.

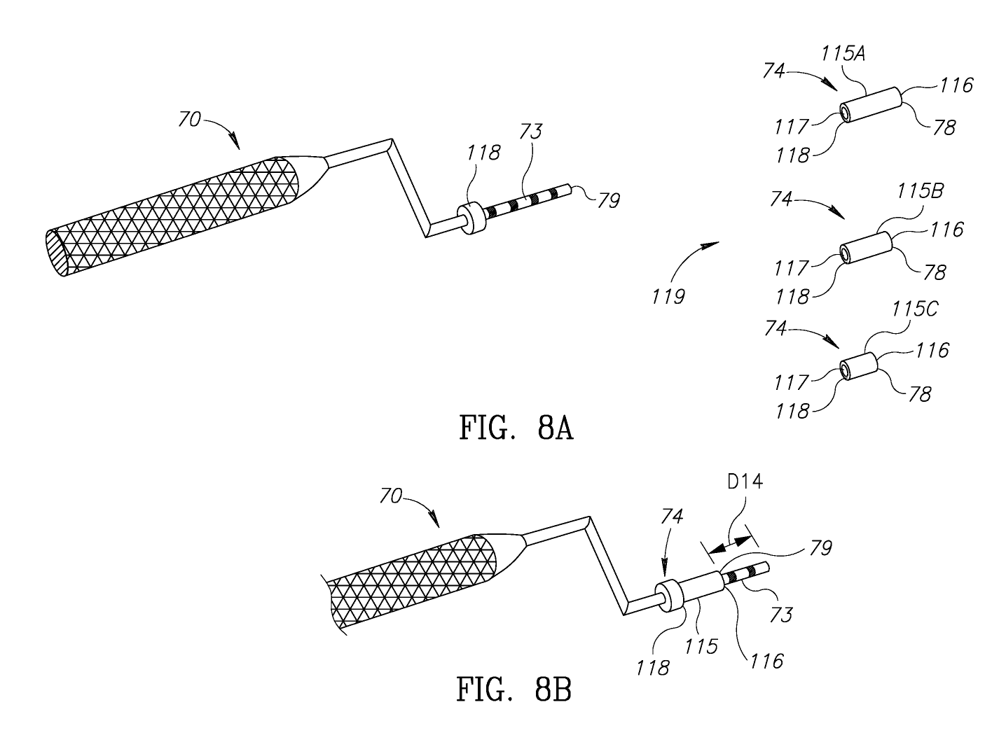

Reference is now made to FIGS. 8A-B, which are schematic illustrations of a single dental probe 70 and a set 119 of proximal stopper skirts 115, in accordance with an application of the present invention. In this configuration, shaft 73 of dental probe 70 is shaped so as to define a proximal shoulder 118. Proximal stoppers 74 comprise proximal stopper skirts 115, respectively, which have respective, different longitudinal lengths. For some applications, as shown in FIGS. 8A-B, external surfaces of proximal stopper skirts 115 are cylindrical.

Respective distal ends 116 of proximal stopper skirts 115 are shaped so as to define respective ones of distal stopper surfaces 78. Proximal stopper skirts 115 are further shaped so as to define respective longitudinal bores 117 therethrough that are shaped and sized to be passable over (a) distal end 79 of dental probe 70 and (b) shaft 73 of dental probe 70, until proximal surfaces 114 of proximal stopper skirts 115 abut proximal shoulder 118 of shaft 73, such that distal stopper surfaces 78 are at the predefined, different distances D14 from distal end 79 of dental probe 70. The skirts thus reduce the effective length of dental probe 70 by the length of the selected skirt.

By way of example and not limitation, set 119 is shown consisting of three proximal stopper skirts 115A, 115B, and 115C. Typically, set 119 consists of between two and eight proximal stopper skirts 115, such as four proximal stopper skirts. Typically, each of the proximal stopper skirts has a longitudinal length of at least 2 mm, no more than 9 mm, and/or between 2 and 9 mm, and typically proximal shoulder 118 is positioned at a distance of at least 3 mm, no more than 10 mm, and/or between 3 and 10 mm from distal end 79 of dental probe 70, such that a difference between (a) the length of each of the skirts and (b) the distance between proximal shoulder 118 and distal end 79 is at least 3 mm, no more than 12 mm, and/or between 3 and 12 mm.

Reference is now made to FIGS. 9A-J, which are schematic illustrations of several steps of a minimally-invasive stent-assisted closed sinus lift surgical procedure for implanting a dental implant, in accordance with an application of the present invention. The procedure is typically employed when a patient's alveolar maxillary bone 120 lacks sufficient bone mass to support a conventional dental implant.

A surgeon begins the procedure by preparing the oral facial region, and administering a local anesthetic. For some applications, as shown in FIGS. 9A-E, a flapless procedure is performed, in which gingiva 122 is not reflected. Alternatively, the surgeon reflects the gingiva, exposing an occlusal surface of maxillary alveolar bone 120 (approach not shown).

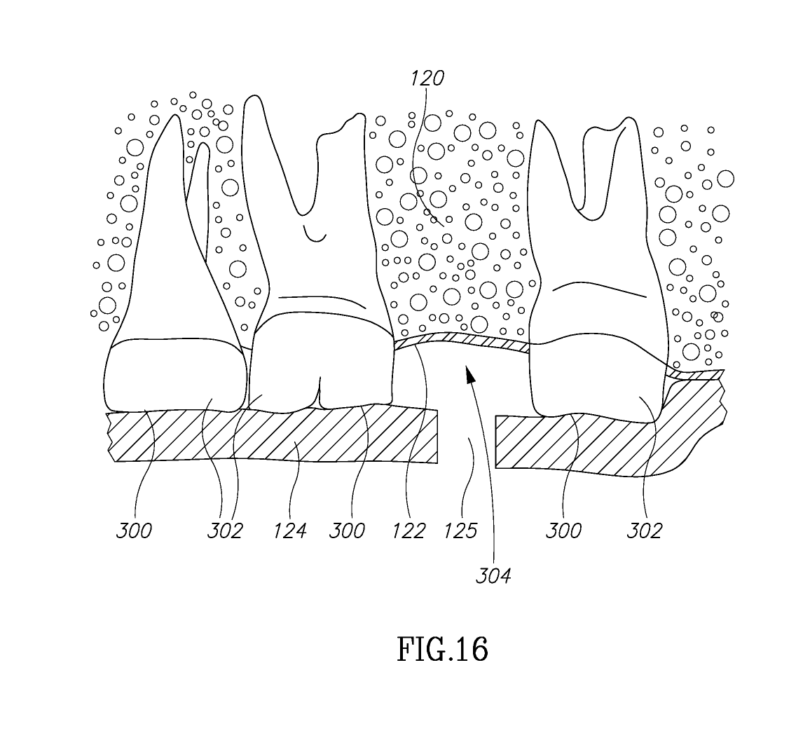

For some applications, as shown in FIG. 9A, the surgeon places a surgical guide stent 124 against an occlusal surface selected from the group consisting of:
an occlusal surface of gingiva 122 covering the maxillary bone, as shown in FIG. 9A;
an occlusal surface of maxillary alveolar bone 120 (i.e., after reflecting the gingiva; configuration not shown); and
an occlusal surface of teeth near a planned dental implant site of the maxillary bone, as described hereinbelow with reference to FIG. 16.

Alternatively, the surgeon applies surgical guide stent 124 at a later stage in the procedure, such as at one of the steps described hereinbelow with reference to 9C, 9D, or 9E. Further alternatively, one or more separate surgical guide stents may be used at the different steps of the procedure, and/or respective inserts (typically ring-shaped) may be inserted into hole 125 at one or more of the different steps of the procedure to provide appropriate internal diameters for the different tools.

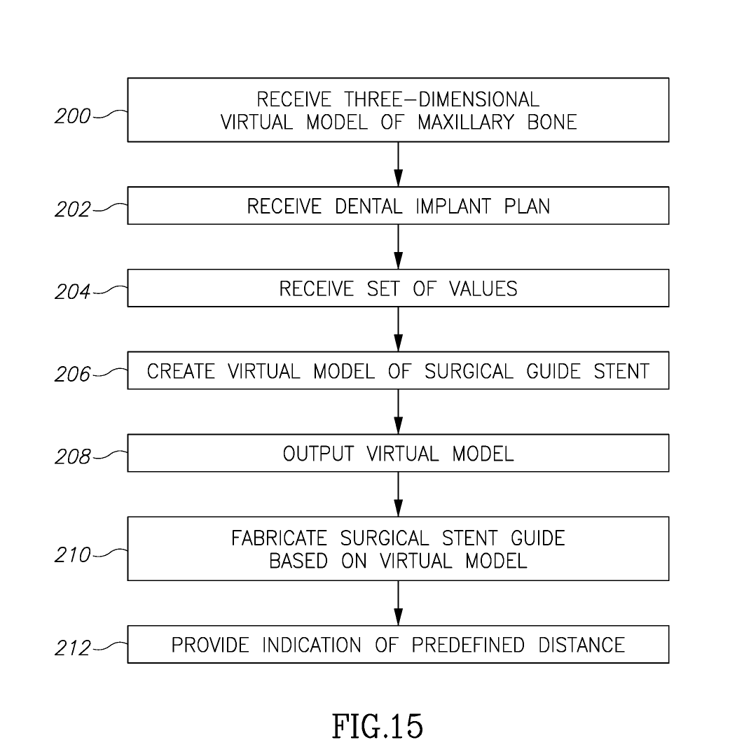

Surgical guide stent 124 is shaped so as to define (a) a hole 125 therethrough at a site corresponding to the planned dental implant site, and (b) an inferior surface 127 surrounding hole 125. For some applications, surgical guide stent 124 is planned and/or fabricated as described hereinbelow with reference to FIG. 15. Surgical guide stent 124 typically additionally helps the surgeon achieve accurate positions and/or angulation of the bore.

Typically, the surgeon forms a preparatory osteotomy through alveolar maxillary bone 120 toward a superior surface of maxillary bone 120. The surgeon aims to extend this preparatory osteotomy to within about 1 to 2 mm from the superior surface of the maxillary bone, without traversing the maxillary bone. As described hereinbelow, for some applications the remaining portion of the osteotomy is traversed using a grinding drill 50, and it would be inefficient to grind through more than about 1 to 2 mm of bone, particularly hard cortical bone.

For some applications, as shown in FIGS. 9B-D, in order to form the preparatory osteotomy, the surgeon forms a preliminary bore 130 through an occlusal cortex 132 (also known as an inferior cortex and the alveolar cortex) into trabecular bone 134 of alveolar bone 120, as shown in FIG. 9B. Preliminary bore 130 typically has a first diameter D5 of between 1.5 and 3 mm, such as between 1.8 and 2.0 mm, and a length L1 of between 1 and 4 mm, such as 3 mm. Typically, the surgeon first marks the drilling location using a marking drill, as is known in the art (step not shown). For some applications, the surgeon forms preliminary bore 130 using pilot drill 20, described hereinabove with reference to FIG. 1. As mentioned above, pilot drill 20 is advanced until shoulder 26 thereof comes in contact with the occlusal surface of occlusal cortex 132, thereby stopping further advancement of the drill. For example, the pilot drill may have a diameter of 2.0 mm. Alternatively, the surgeon forms preliminary bore 130 using another dental drill, such as a conventional twist drill.

As shown in FIG. 9C, the surgeon optionally widens a proximal portion 140 of preliminary bore 130 to a second diameter D6 greater than first diameter D5, typically without widening a distal portion of preliminary bore beyond first diameter D5. For some applications, proximal portion 140 is entirely within occlusal cortex 132 (as shown), while for other applications, the proximal portion extends from the occlusal cortex partially into trabecular bone 134 (not shown). The surgeon typically performs this step using a counterbore drill, such as counterbore drill 30, described hereinabove with reference to FIG. 1. The widened bore serves to position the drill used in the next step of the method, described with reference to FIG. 9D. Alternatively, preliminary bore 130 is not widened, and the transition between drills of increasing diameters is performed without widening the diameter of the proximal portion of the osteotomy.

As shown in FIG. 9D, after widening the portion of the preliminary bore, the surgeon advances another drill in preliminary bore 130, such as drill 40, described hereinabove with reference to FIGS. 1 and 2, or another drill, to form a preparatory osteotomy. Drill 40 has distal cutting edge 42, which optionally is flat. If necessary, advancing this drill into preliminary bore 130 lengthens preliminary bore 130. For applications in which surgical guide stent 124 has been applied, the surgeon inserts distal end 49 of drill 40 through hole 125 of the surgical guide stent.

For some applications in which drill 40 is used, in order to form the preparatory osteotomy through trabecular bone 134 up to, but not into, a superior cortex 126 (also known as a sinus cortex), the surgeon ceases advancing drill 40 at the earlier of:
a distal end of drill 40 reaching an occlusal surface 142 of superior cortex 126 of alveolar bone 120, such. Flat distal cutting edge 42 generally provides a sharp, rapid change in resistance when the distal end of drill 40 comes in contact with the hard superior cortex. The surgeon can readily detect this sharp change in resistance, in order to identify when to cease advancing the drill. The increase in resistance may be detected by manually feeling the change in resistance. Alternatively, the increase in resistance may be detected using a tool to measure torque, e.g., by observing an increase in the displayed torque on the drilling unit. (In contrast, if the drill were pointed, the sensed transition would be more gradual.); and
for applications in which surgical guide stent 124 has been applied, until distal stopper surface 48 of proximal stopper 44 of drill 40 coming in contact with inferior surface 127 surrounding hole 125 of surgical guide stent 124.

For applications in which set 46 of drills 40 is provided, the surgeon selects the appropriate drill 40 from the set. This drill is the one that has an appropriate distance D4, as described hereinabove with reference to FIG. 2, such that distal stopper surface 48 of proximal stopper 44 comes in contact with inferior surface 127 of surgical guide stent 124 before or at the same time that distal end 49 of drill 40 reaches occlusal surface 142 of superior cortex 126, or reaches a certain distance from the sinus floor, such as between 1 and 2 mm. Proximal stopper 44 thus prevents accidental overdrilling into superior cortex 126. Alternatively or additionally, proximal stopper 44 brings grinding drill 50 to the proper maximum distance from the sinus floor for the grinding drill to work effectively. For some applications, the surgeon selects the appropriate drill 40 from the set responsively to a selection indication received from a provider of surgical guide stent 124, as described hereinbelow regarding grinding drills 50 with reference to FIG. 15, mutatis mutandis. For example, the selection indication may be a color, number, and/or letter marked on surgical guide stent 124 or provided on or in packaging in which surgical guide stent 124 is provided to the surgeon.

Alternatively, for some applications, shaft 41 of drill 40 is shaped so as to define a proximal shoulder, similar to proximal shoulder 108 of grinding drill 50, described hereinabove with reference to FIGS. 7A-B. Proximal stoppers 44 comprise a set of proximal stopper skirts that have respective, different longitudinal lengths, similar to proximal stopper skirts 110, described hereinabove with reference to FIGS. 7A-B. The surgeon selects the appropriate skirt from the set of skirts. This skirt is the one that has a distal stopper surface at an appropriate distance from the distal end of drill 40, similar to distance D13 described hereinabove with reference to FIGS. 7A-B. The surgeon passes the selected skirt over (a) the distal end of drill 40 and (b) shaft 41 of drill 40, until a proximal surface of the selected skirt abuts the proximal shoulder of shaft 41. For these applications, typically only a single drill 40 is provided.

If preliminary bore 130 initially has a curved bore end, flat distal cutting edge 42 also flattens the bore end. Alternatively, the surgeon does not advance drill 40 all of the way to superior cortex 126. The surgeon may sometimes form the preparatory osteotomy through trabecular bone 134 and partially through superior cortex 126. Typically, drill 40 has a greatest outer diameter D7 within 1 mm of second diameter D6, i.e., equal to D6 +/−1 mm.

Depending on the surgical plan for the particular patient, the surgeon may repeat the widening steps described above with reference to FIGS. 9C and 9D two or three times. For example, the widening steps may first be performed with (a) a counterbore drill 30, portions 34 and 36 of which have, for example, diameters of 2.0 and 2.8 mm, respectively, and (b) a drill 40 having a diameter of, for example, 2.8 mm. If additional widening is required, the widening steps of FIGS. 9C and 9D may be repeated with (a) a wider counterbore drill 30, portions 34 and 36 of which have, for example, diameters of 2.8 and 3.2 mm, respectively, and (b) a wider drill 40 having a diameter of, for example, 3.2 mm. If still more widening is required, the widening of steps of FIGS. 9C and 9D may be repeated yet again with (a) a still wider counterbore drill 30, portions 34 and 36 of which have, for example, diameters of 3.2 and 3.65 mm, respectively, and (b) a still wider drill 40 having a diameter of, for example, 3.65 mm. Alternatively, the widening may be performed without using a counterbore drill between the successive drill diameters.

When completely formed, the preparatory osteotomy typically has a diameter of between 2 and 7 mm, e.g., between 3 and 6 mm, such as either 3.2 or 3.65 mm, and leaves residual bone thickness of between 1 and 2 mm.

The surgeon subsequently lengthens the preparatory osteotomy (i.e., bore) through (typically, completely through) maxillary bone 120 (including at least a portion of superior cortex 126) using grinding drill 50, as shown in FIG. 9E. This lengthening step is performed after the last widening iteration described above with reference to FIGS. 9C and 9D. For example, shaft 81 of grinding drill 50 may have a diameter of 3.2 mm or 3.65 mm. This step may also optionally be additionally performed after an earlier widening step, such as after the middle widening step if three widening steps are performed.

The surgeon inserts grinding drill 50, described hereinabove with reference to FIGS. 3, 4A-B, and 5, through hole 125 of surgical guide stent 124 and into the preparatory osteotomy. The surgeon advances grinding drill 50 through maxillary bone 120 in the preparatory osteotomy (i.e., bore), such that distal grinding surface 84 lengthens the bore by grinding into maxillary bone 120. Distal grinding surface 84 is configured to grind (e.g., abrade) maxillary bone 120 to a determined (typically, predetermined) depth (typically between 0.5 and 2 mm), until distal end 95 of grinding drill 50 slightly penetrates beyond the superior cortex into a Schneiderian membrane 144. However, because distal grinding surface 84 is typically devoid of large cutting surfaces (and optionally may have a generally blunt outer contour), even if the distal grinding surface 84 penetrates beyond the superior cortex, the distal grinding surface generally does not perforate or otherwise damage the Schneiderian membrane, but instead gently pushes against the membrane. This grinding may produce a layer of ground bone at the interface with the membrane.

In order to achieve the proper depth of advancement of grinding drill 50, the surgeon typically ceases advancing grinding drill 50 when distal stopper surface 97 of proximal stopper 54 of grinding drill 50 comes in contact with inferior surface 127 surrounding hole 125 of surgical guide stent 124.

Optionally, for applications in which distal shoulder 90 is provided, the surgeon may also cease advancing grinding drill 50 when distal shoulder 90 reaches an end of the preparatory osteotomy. For some applications, the surgeon ceases advancing in response to a sensed contact of the distal shoulder with occlusal surface 142 of superior cortex 126 (e.g., sensed manually, or using a sensor element). The distal shoulder thus inhibits grinding protrusion 82 from advancing into superior cortex 126 more than distance D3, described hereinabove with reference to FIGS. 4A-B. Because distal shoulder 90 does not define a cutting surface, the distal shoulder does not cut into occlusal surface 142, and is thus blocked from further advancement by the occlusal surface. Alternatively, distal shoulder 90 impedes and/or slows but does not block the advancement of the drill into the cortex.

Alternatively or additionally, the surgeon may optionally use fiducial designators 100 (optionally, in combination with one or both of the above techniques) to accurately gauge the depth of insertion of distal grinding surface 84 into maxillary bone 120. For example, the surgeon may decide to advance the grinding surface a desired depth into maxillary bone.

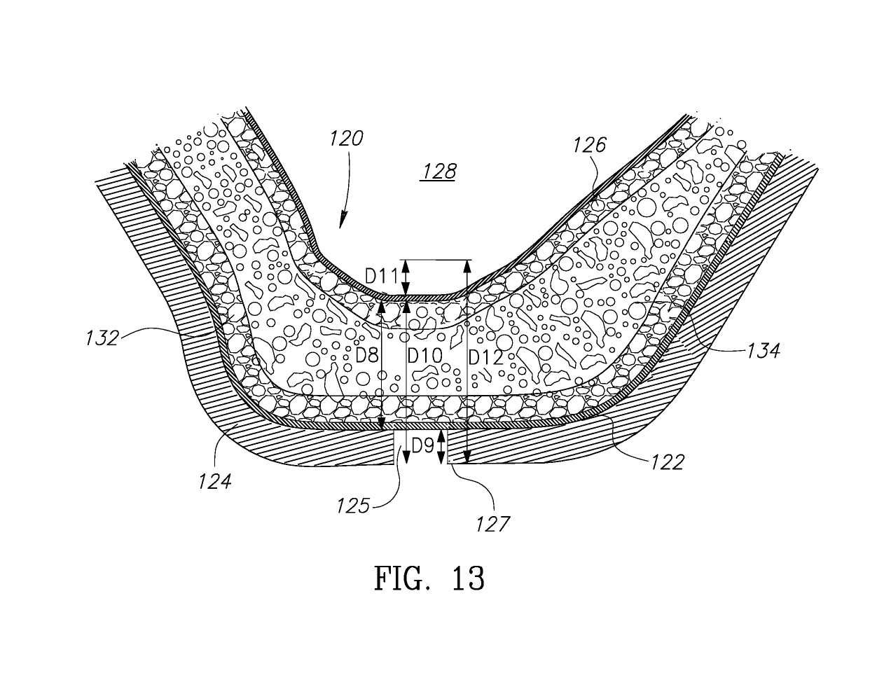

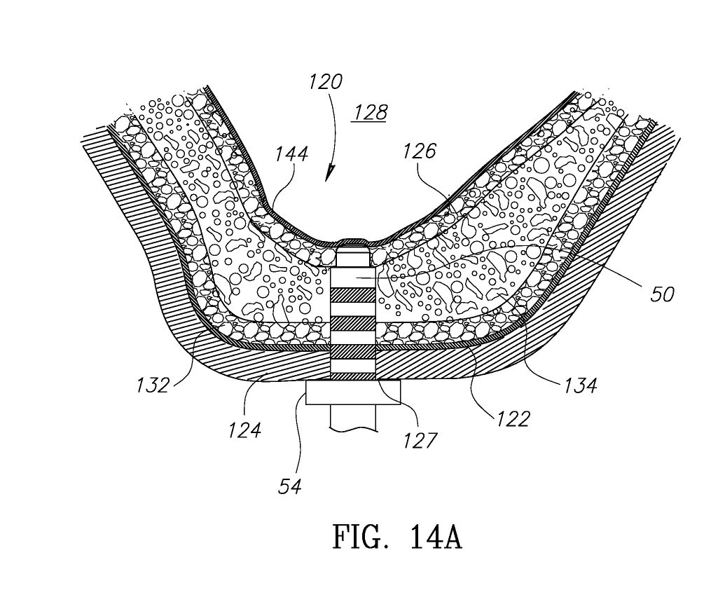

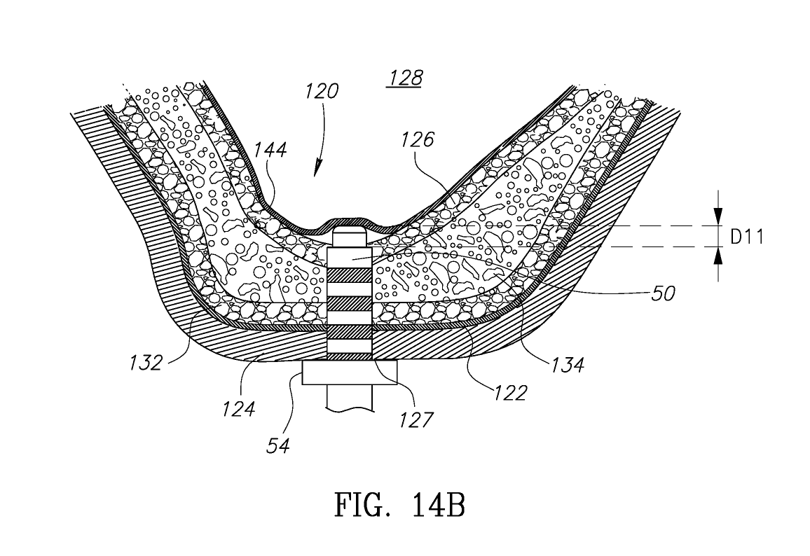

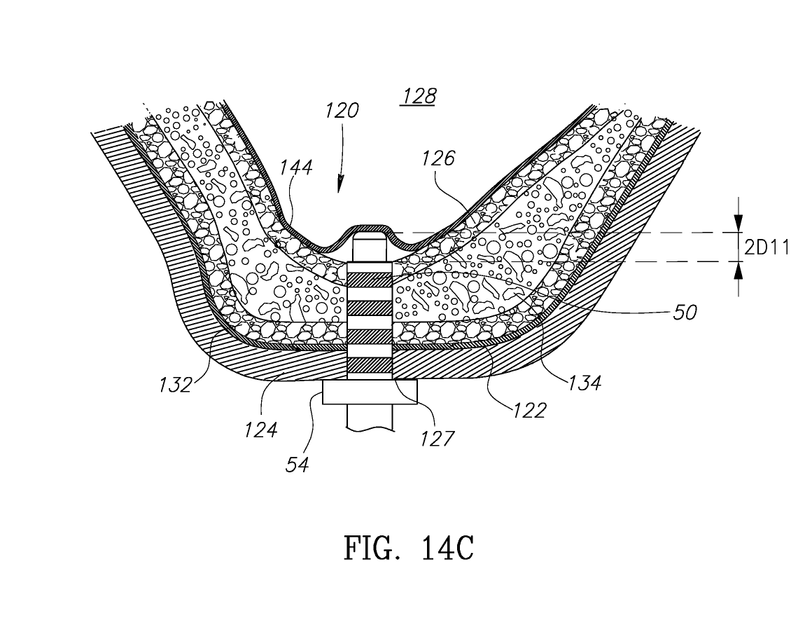

For some applications, as described hereinbelow with reference to FIGS. 13 and 14A-C, the surgeon uses a grinding drill 50 that has a proximal stopper 54 with a distal stopper surface 97 at a predefined distance D13 (labeled in FIGS. 3 and 5), which predefined distance equals a sum of (i) a distance between inferior surface 127 surrounding hole 125 and a superior surface of maxillary bone 120 and (ii) an over-advancement depth D11 equal to between 0.1 and 4 mm, such as between 0.2 and 2.5 mm, e.g., 0.5 to 1.5 mm. Over-advancement depth D11 is described in detail hereinbelow with reference to FIGS. 13 and 14A-C.

For applications in which set 56 of grinding drills 50 is provided, the surgeon selects the appropriate grinding drill 50 from the set. This drill is the one which has an appropriate distance D13, as described hereinabove with reference to FIG. 5, such that distal stopper surface 97 of proximal stopper 54 comes in contact with inferior surface 127 of surgical guide stent 124 at the same time as or soon after distal grinding surface 84 of grinding drill 50 reaches Schneiderian membrane 144. Proximal stopper 54 thus prevents accidental excessive overdrilling into Schneiderian membrane 144. For some applications, the surgeon selects the appropriate grinding drill 50 from the set responsively to a selection indication received from a provider of surgical guide stent 124, as described hereinbelow with reference to FIG. 15. For example, the selection indication may be a color, number, and/or letter marked on surgical guide stent 124 or provided on or in packaging in which surgical guide stent 124 is provided to the surgeon.

Alternatively, for some applications, such as described hereinabove with reference to FIGS. 7A-B, set 109 of proximal stopper skirts 110 is provided, and shaft 81 of grinding drill 50 is shaped so as to define proximal shoulder 108. The surgeon selects the appropriate skirt from set 109. This skirt is the one that has a distal stopper surface 97 at an appropriate distance D13 from distal end 95 of grinding drill 50, as described hereinabove with reference to FIGS. 7A-B. The surgeon passes the selected skirt 110 over (a) distal end 95 of grinding drill 50 and (b) shaft 81 of grinding drill 50, until a proximal surface 114 of the selected skirt 110 abuts proximal shoulder 108 of shaft 81. For some applications, the surgeon selects the appropriate skirt 110 from the set responsively to a selection indication received from a provider of surgical guide stent 124, as described hereinbelow with reference to FIG. 15. For example, the selection indication may be a color, number, and/or letter marked on surgical guide stent 124 or provided on or in packaging in which surgical guide stent 124 is provided to the surgeon.

Typically, portion 92 of shaft 81 of grinding drill 50 has a diameter approximately equal to a diameter of the preparatory osteotomy, to minimize lateral movement of grinding drill 50 in the osteotomy. Typically, a diameter of the flat drill is approximately equal (e.g., within +/−10%) of diameter D2 of portion 92 of shaft 81 that is proximally adjacent to grinding protrusion 82 of grinding drill 50 (see FIGS. 3 and 4A-B).

The surgeon withdraws grinding drill 50 from alveolar bone 120.

Optionally, the surgeon uses one of dental probes 70, described hereinabove with reference to FIGS. 1 and 6, to check whether Schneiderian membrane 144 is intact, using techniques described hereinbelow with reference to FIG. 12.

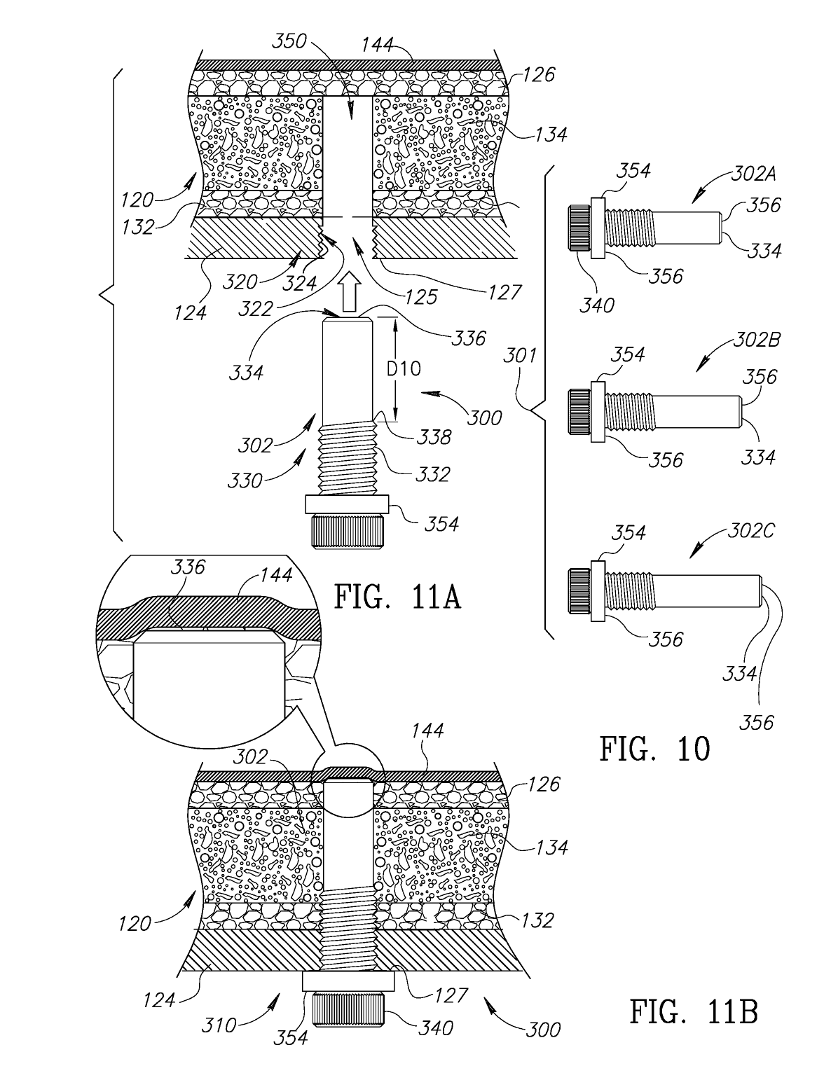

As shown in FIG. 9F, the surgeon optionally removes surgical guide stent 124 and advances a dental implement into the preparatory osteotomy, such as by rotating the dental implement, until the distal end of the dental implement reaches the superior surface of maxillary bone 120 and Schneiderian membrane 144. For some applications, the dental implement comprises a dental implant 150, which may comprise one of the dental implants described in PCT Publication WO 2010/035270, PCT Publication WO 2010/146573, U.S. Pat. No. 7,934,929, U.S. Pat. No. 8,029,284, U.S. Pat. No. 8,388,343, US Patent Application Publication 2012/0094254, and/or U.S. patent application Ser. No. 13/314,740 (collectively referred to hereinbelow as the “Assignee Publications”), all of which are assigned to the assignee of the present application and are incorporated herein by reference. For example, for applications in which the dental implement comprises a dental implant, the implant may have a diameter of between 2.5 and 7.0 mm, such as 3.7 mm, 4.2 mm, or 5.0 mm, depending on the diameter of the osteotomy. For some applications, the dental implant is rotated using techniques and/or tools described in one or more of the Assignee Publications. For other applications, the dental implement may comprise an osteotome, such as osteotome 302 described hereinbelow with reference to FIGS. 10 and 11A-B. For these other applications, surgical guide stent 124 is typically left in place at this step of the procedure.

For some applications, an external lateral surface of dental implant 150 is shaped so as to define a screw thread, which extends until the distal end of the implant. The screw thread helps advance the implant distally through the remaining cortical bone, engaging the perimeter of the bore formed in the residual bone of the cortex. In addition, the screw thread forms a tight liquid seal with the perimeter of the bore, which facilitates the subsequent injection of fluids to the sub-membrane space without leakage into the trabecular bone or out back through the osteotomy.

For applications in which dental implant 150 is shaped so as to define a lumen therethrough that opens through a distal external surface, such as described in the Assignee Publications, the implant procedure continues as described with reference to FIGS. 9G-J.

As shown in FIG. 9G, the surgeon attaches an applicator 160 to a proximal end of dental implant 150, such as using techniques described in one or more of the Assignee Publications. Alternatively, applicator 160 is attached to the dental implant prior to beginning the procedure. The surgeon couples a retaining assembly 162 to applicator 160, and deploys the retaining assembly such that retaining assembly 162 sealingly couples a delivery tube 170 to a lateral opening 172 of the implant, as shown in FIG. 9H. For some applications, a sealing element at the distal end of delivery tube is configured as described in above-mentioned US Patent Application Publication 2012/0094254 with reference to FIG. 30 thereof. Lateral opening 172 of the implant is in fluid communication with the implant lumen that leads to the distal external surface of the implant, as described in the Assignee Publications. The distal end of delivery tube 170 may be held tightly against lateral opening 172 by tightening a knob 174 such that a screw 176 connected to the knob presses against applicator 160.

As shown in FIG. 9I, the surgeon gently lifts and separates membrane 144 from the top of maxillary bone 120 into a maxillary sinus 180. In order to do so, the surgeon injects a fluid 182 from a fluid source (not shown), such as via a fluid connector 184 (e.g., a female luer connector), via delivery tube 170 and the lumen of implant 150, so as to form a cavity in maxillary sinus 180 under the membrane between the maxillary bone and the membrane. Typically, fluid 182 is a biocompatible solution such as normal saline solution or a gas. Typically, the surgeon injects sufficient fluid 182 into the cavity to inflate the cavity to a vertical height of between about 2 and about 20 mm from the top of bone 120, such as between about 2 and about 11 mm, e.g., between about 2 and about 8 mm. For some applications, a measured volume of fluid 182 is injected in order to achieve the desired cavity height, such as between about 0.5 and about 6 ml of fluid, e.g., between about 1 and about 4 ml, or between about 2 and about 4 ml. It is noted that the thread of the implant engages the dense cortical bone, forming a tight liquid seal with the bone, while vertical slots of the implant typically fill with compacted bone dust, maintaining this tight liquid seal with the bone.

The fluid is typically drained from the cavity, and the surgeon injects a regenerative material 186, such as liquid or gel bone graft, into the cavity. The fluid source or a separate syringe or powered drug delivery device is used for injecting the regenerative material. Regenerative material 186 may comprise an allograph, an autogeneous bone graft, or a xenograft, and may, for example, comprise a natural material, a synthetic material, or a mixture thereof. For example, regenerative material 186 may comprise one of the following commercially available fluid bone graft materials: MBCP Gel (Biomatlante), DBX Paste (MTF), Allomatrix (Wright), Cerament (Bone Support), DynaGraft (Citagenix/ISOTIS), Fisiograft (Ghimas), Grafton (Osteotech), Optium DBM Gel (Lifenet/Depuy J&J), OsteoMax (Orthfix), PD VitalOs Cemen (VitalOs), Regenafil® (Exactech), or fluids containing an active biological ingredient such as bone morphogenetic protein.

Alternatively, the surgeon injects regenerative material 186, rather than fluid 182, to lift membrane 144, thereby combining two steps of the procedure described above. In this case, the regenerative material typically comprises a liquid.

The surgeon decouples delivery tube 170 from implant 150, and retaining assembly 162 from applicator 160, as shown in FIG. 9J.

The surgeon further advances (e.g., by rotating or screwing) implant 150 into regenerative material 186 in the cavity, and detaches applicator 160 from implant 150, as shown in FIG. 4M of the above-mentioned '740 application. For some applications, techniques are used that are described in the Assignee Publications. Implant 150 is advanced at least until lateral opening 172 of the implant is positioned entirely within the bore in bone 120 and/or in regenerative material 186 in the cavity. Such positioning of both ends of the lumen of the implant within bone substantially reduces the risk of infection, because the proximal end of the implant that is exposed to the oral cavity or gingiva is permanently closed. Typically, the surgeon couples a cover screw to the proximal end of the implant using a hand driver, and sutures the gingiva.

As shown in FIG. 9N of the above-mentioned '740 application, after bone grows into regenerative material 186 and is integrated into bone 120, an appliance 190, such as a crown, is coupled to implant 150, typically using an abutment 192 coupled to implant 150, as is known in the art. Alternatively, implant 150 comprises a single-stage transgingival implant/abutment, as is known in the art.

Reference is now made to FIGS. 10 and 11A-B, which are schematic illustrations of a dental system 300 and a method for its use, in accordance with an application of the present invention. Dental system 300 is used for performing a stent-assisted sinus lift procedure, and comprises surgical guide stent 124 and a set 301 of dental osteotomes 302. Dental system 300 allows the screwing of dental osteotome 302 into an osteotomy, and removal of the osteotome from the osteotomy, without damaging the internal wall of the osteotomy or occlusal cortex 132. Typically, each osteotome 302 comprises a handle 340, as shown, or an interface to another tool, such as a ratchet wrench (configuration not shown).

Each osteotome 302 is shaped so as to define a shaft 303 and, for some applications, a distal grinding surface 336 (i.e., an abrasive surface). Typically, distal grinding surface 336 is devoid of large cutting surfaces (and optionally may have a generally blunt outer contour) and includes a portion perpendicular to a central longitudinal axis of osteotome 302, which portion is generally flat or convexly curved. For some applications, the distal grinding surface includes a surface selected from the group consisting of: a diamond bur (e.g., comprising embedded diamond particles), a carbide bur (e.g., having a fine mesh of cutting edges, for example crisscrossed), a stainless steel bur, a titanium bur, a slotted surface, a roughened surface, and a surface shaped so as to define a plurality of small blades (e.g., each protruding less than 1 mm from the distal surface). Alternatively, for some applications, the distal grinding surface comprise at least one end mill cutter surface. Osteotome 302 is sized and shaped for distal-end-first insertion through hole 125 of surgical guide stent 124, as described hereinbelow with reference to FIGS. 11A-B.

For other applications, rather than distal grinding surface 336, each osteotome 302 instead is shaped so as to define a cutting or a cracking surface.

Shaft 303 has, e.g., is shaped so as to define, a proximal stopper 354. Proximal stopper 354 has a distal stopper surface 356 at a predefined distance from a distal end 334 of osteotome 302. Proximal stoppers 354 of osteotomes 302 of set 301 are disposed such that distal stopper surfaces 356 are at respective, different distances D4 from respective distal ends 334. By way of example and not limitation, set 301 is shown consisting of three dental osteotomes 302A, 302B, and 302C, having distal stopper surfaces at respective distances from respective distal ends 334. Typically, set 301 consists of between two and eight dental osteotomes 302, such as four dental osteotomes. Typically, each of the distances is at least 2 mm, no more than 10 mm, and/or between 2 and 10 mm, such as at least 3 mm, no more than 8 mm, and/or between 3 and 8 mm.

For some applications, each of osteotomes 302 is further shaped so as to define a grinding protrusion, which may have the structure of grinding protrusion 82 of grinding drill 50, described hereinabove with reference to FIGS. 3 and 4A-B. The grinding protrusion of osteotome 302 defines at least distal grinding surface 336, and, optionally, a lateral grinding surface 86. Like grinding protrusion 82, the grinding protrusion of osteotome 302 is coaxial with and extends distally from shaft 303 at an interface that defines a distal shoulder. The distal shoulder does not define a grinding surface, such that the distal shoulder is not configured to cut into cortical bone. The distal shoulder thus is configured to stop advancement of the drill when the distal shoulder comes in contact with cortical bone, such as described hereinabove with FIG. 9E, mutatis mutandis. Alternatively or additionally, the distal shoulder slows advancement of the drill, thereby allowing easy control of advancement depth of the drill, optionally in conjunction with the use of visually-sensible fiducial designators, similar to visually-sensible fiducial designators 100, described hereinabove with reference to FIG. 3. The grinding protrusion of osteotome 302 may have the dimensions described hereinabove for grinding protrusion 82.

The surgeon uses one of osteotomes 302 to lengthen a preparatory osteotomy (i.e., bore) through (typically, completely through) maxillary bone 120 (including at least a portion of superior cortex 126). This lengthening step may be performed after the last widening iteration described above with reference to FIGS. 9C and 9D. The surgeon inserts osteotome 302 through hole 125 of surgical guide stent 124 and into the preparatory osteotomy. The surgeon advances osteotome 302 through maxillary bone 120 in the preparatory osteotomy (i.e., bore), such as by rotating the osteotome, so that distal grinding surface 336 lengthens the bore by grinding into maxillary bone 120. Distal grinding surface 336 is configured to grind (e.g., abrade) maxillary bone 120 to a determined (typically, predetermined) depth (typically between 0.5 and 2 mm), until distal end 334 of osteotome 302 slightly penetrates beyond the superior cortex into a Schneiderian membrane 144. However, because distal grinding surface 336 is typically devoid of large cutting surfaces (and optionally may have a generally blunt outer contour), even if the distal grinding surface 336 penetrates beyond the superior cortex, the surface generally does not perforate or otherwise damage the Schneiderian membrane, but instead gently pushes against the membrane.

In order to achieve the proper depth of advancement of osteotome 302, the surgeon typically ceases advancing osteotome 302 when distal stopper surface 356 of proximal stopper 354 comes in contact with inferior surface 127 surrounding hole 125 of surgical guide stent 124.

Optionally, for applications in which the distal shoulder is provided, the surgeon may also cease advancing the osteotome when the distal shoulder reaches an end of the preparatory osteotomy. For some applications, the surgeon ceases advancing in response to a sensed contact of the distal shoulder with occlusal surface 142 of superior cortex 126 (e.g., sensed manually, or using a sensor element). The distal shoulder thus inhibits the grinding protrusion from advancing into superior cortex 126 more than the predefined distance between distal stopper surface 356 and distal end 334 of osteotome 302. Because the distal shoulder does not define a cutting surface, the distal shoulder does not cut into occlusal surface 142, and is thus blocked from further advancement by the occlusal surface. Alternatively, the distal shoulder impedes and/or slows but does not block the advancement of the osteotome into the cortex.

Alternatively or additionally, the surgeon may optionally use fiducial designators (optionally, in combination with one or both of the above techniques) to accurately gauge the depth of insertion of distal grinding surface 336 into maxillary bone 120. For example, the surgeon may decide to advance the cutting surface a desired depth into the maxillary bone.

For some applications, as described hereinbelow with reference to FIGS. 13 and 14A-C, the surgeon uses a osteotome 302 that has a proximal stopper 354 with a distal stopper surface 356 at a predefined distance D13 between distal stopper surface 356 and distal end 334 of osteotome 302, which predefined distance equals a sum of (i) a distance between inferior surface 127 surrounding hole 125 and a superior surface of maxillary bone 120 and (ii) an over-advancement depth D11 equal to between 0.1 and 4 mm, such as between 0.2 and 2.5 mm, e.g., 0.5 to 1.5 mm. Over-advancement depth D11 is described in detail hereinbelow with reference to FIGS. 13 and 14A-C.

For applications in which set 301 of osteotomes 302 is provided, the surgeon selects the appropriate osteotome 302 from the set. This osteotome is the one which has an appropriate predefined distance, such that distal stopper surface 356 of proximal stopper 354 comes in contact with inferior surface 127 of surgical guide stent 124 at the same time as or soon after distal grinding surface 336 of osteotome 302 reaches Schneiderian membrane 144. Proximal stopper 354 thus prevents accidental excessive overdrilling into Schneiderian membrane 144. For some applications, the surgeon selects the appropriate osteotome 302 from the set responsively to a selection indication received from a provider of surgical guide stent 124, as described hereinbelow with reference to FIG. 15. For example, the selection indication may be a color, number, and/or letter marked on surgical guide stent 124 or provided on or in packaging in which surgical guide stent 124 is provided to the surgeon.

Alternatively, for some applications, shaft 303 of osteotome 302 is shaped so as to define a proximal shoulder, similar to proximal shoulder 108 of grinding drill 50, described hereinabove with reference to FIGS. 7A-B. Proximal stoppers 354 comprise a set of proximal stopper skirts that have respective, different longitudinal lengths, similar to proximal stopper skirts 110, described hereinabove with reference to FIGS. 7A-B. The surgeon selects the appropriate skirt from the set of skirts. This skirt is the one that has a distal stopper surface at an appropriate distance from distal end 334 of osteotome 302, similar to distance D13 described hereinabove with reference to FIGS. 7A-B. The surgeon passes the selected skirt over (a) distal end 334 of osteotome 302 and (b) shaft 303 of osteotome 302, until a proximal surface of the selected skirt abuts the proximal shoulder of shaft 303. For these applications, typically only a single osteotome 302 is provided.

The surgeon removes osteotome 302 from the osteotomy. Optionally, the surgeon inserts a dental implant into the completed osteotomy. For applications in which the dental implant is shaped so as to define a lumen therethrough that opens through a distal external surface, such as described hereinabove and/or in the Assignee Publications, the implant procedure continues as described hereinabove with reference to FIGS. 9F-J.

Alternatively, for some applications, distal end 334 defines a non-grinding cutting surface, such as a cracking tip, and the surgeon lengthens the bore by cracking bone of the maxillary bone. For some applications, osteotome 302 comprises an impact dental osteotome, and the surgeon lengthens the bore by applying a longitudinal impact to the impact dental osteotome. Contact between distal stopper surface 356 of proximal stopper 354 and inferior surface 127 surrounding hole 125 prevents over-advancement of the impact osteotome. Optionally, surgical guide stent 124 comprises a shock-absorbing element (typically comprising a spring and/or flexible element such as rubber), coupled to inferior surface 127 around hole 125, in order to absorb a portion of the impact applied by distal stopper surface 356 of proximal stopper 354 to inferior surface 127 surrounding hole 125. This may prevent excessive impact to the bone and/or reduce the risk of vertigo.

For some applications, after forming the osteotomy and before breaking superior cortex 126 using dental osteotome 302, the surgeon weakens superior cortex 126 using grinding drill 50, using the techniques described hereinabove with reference to FIG. 9E.

For some applications, hole 125 of surgical guide stent 124 is shaped so as to define a cylindrical surface 322 that is shaped so as to define an internal thread 324. The cylindrical surface may be fabricated as an integral part of the surgical guide stent (e.g., from the same material), or may comprise a separate element, e.g., a metal ring, that is coupled to the surgical guide stent. For these applications, osteotome 302 has an outer surface 330, a portion of which is shaped so as to define an external thread 332 that is configured to engage internal thread 324 of cylindrical surface 322 of surgical guide stent 124. For some applications, a distal end 338 of external thread 332 of dental osteotome 302 is at least a distance D10 of 4 mm from distal end 334 of dental osteotome 302. For other applications, external thread 332 extends distally closer to distal end 334 of dental osteotome 302, such as to the distal end of the dental implement. For these applications, the diameter of the osteotome is typically less than the diameter of osteotomy 350, so that the thread does not engage the inner wall of the osteotomy.

During the procedure, the surgeon engages, with internal thread 324 of cylindrical inner surface 322 of surgical guide stent 124, external thread 332 defined by outer surface 330 of a portion of dental osteotome 302 (other than the cutting tool). While dental osteotome 302 is engaged with cylindrical surface 322, the surgeon rotates dental osteotome 302 such that the dental implement advances into osteotomy 350. The surgeon grinds, cut, or cracks through maxillary bone 120 using dental osteotome 302. Surgical guide stent 124, rather than occlusal cortex 132 and trabecular bone 134, provides most of the mechanical support for the rotation of dental osteotome 302. As a result, the rotation of the osteotome does not weaken the occlusal cortex or trabecular bone. Optionally, surgical guide stent 124 may additionally provide guidance for the dental implement. Optionally, the surgeon uses dental osteotome 302 to elevate the Schneiderian membrane and/or to insert a regenerative material into a cavity formed under the Schneiderian membrane, such as described hereinabove and/or in the Assignee Publications.

For some applications, osteotome 302 is shaped so as to define a lumen therethrough, having a distal end that opens through at least one distal opening on a distal end of the osteotome, and a proximal end that opens through a proximal opening on a proximal end of the osteotome. After fully advancing the osteotome, the surgeon injects a fluid into the proximal end of the lumen, through the lumen, and out of the distal end of the lumen, in order to raise the membrane, for example using techniques described in the Assignee Publications.

For some applications, the techniques described above with reference to FIGS. 10 and 11A-B are used for performing a crestal sinus lift. Alternatively, these techniques may be used for performing a lateral sinus lift, such as if a prosthesis is already in place before the procedure.

Reference is now made to FIG. 12, which is a schematic illustration of a dental probing technique, in accordance with an application of the present invention. This probing techniques uses probe 70, described hereinabove with reference to FIGS. 1 and 6, and optionally, set 76 of probes 70, described hereinabove with reference to FIG. 6. This probing technique may be used in combination with apparatus and techniques described herein, such as between the procedural steps described hereinabove with reference to FIGS. 9E and 9F, or after the procedural step described hereinabove with reference to FIG. 11B. Alternatively, this probing technique may be used during a sinus lift procedure performed using techniques described in the Assignee Publications and/or known in the art.

After completing a bore through maxillary bone 120, the surgeon uses this probing technique to ascertain whether Schneiderian membrane 144 is intact. Naively probing the membrane, without the use of this technique, may increase the risk of membrane perforation. Over-advancement is necessary in order to feel the elastic response of the membrane which indicates that it is intact. In addition, further over-advancement overcomes inaccuracies in stent design, manufacture, and usage, as described herein.

The surgeon places surgical guide stent 124 against a selected occlusal surface, such as described hereinabove with reference to FIG. 9A. Alternatively, the surgeon uses surgical guide stent 124 that was previously placed against the occlusal surface during an earlier portion of the sinus lift procedure. The surgeon inserts distal end 79 of dental probe 70 through hole 125 of surgical guide stent 124, and advances the dental probe through the maxillary bone. The surgeon typically ceases advancing the dental probe at the earlier of:
the surgeon's sensing that distal end 79 comes in contact with Schneiderian membrane 144, e.g., sensing the elastic response of the membrane; and
distal stopper surface 78 coming into contact with inferior surface 127 surrounding hole 125 of surgical guide stent 124.

Alternatively or additionally, the surgeon may optionally use fiducial designators 75 (optionally, in combination with one or both of the above techniques) to accurately gauge the depth of insertion of distal end 79 of probe 70 into maxillary bone 120.

During advancement of the probe, the surgeon senses elasticity of the membrane using the dental probe. Lack of an elastic sensation may indicate perforation of the membrane.

For some applications, as described hereinbelow with reference to FIGS. 13 and 14A-C, the surgeon uses a probe 70 that has a proximal stopper 74 with a distal stopper surface 78 at a predefined distance D13 between distal stopper surface 78 and distal end 79 of probe 70, which predefined distance equals a sum of (i) a distance between inferior surface 127 surrounding hole 125 and a superior surface of maxillary bone 120 and (ii) an over-advancement depth D11 equal to between 1 and 5 mm, such as between 2 and 3 mm. Over-advancement depth D11 is described in detail hereinbelow with reference to FIGS. 13 and 14A-C. The desired over-advancement depth of probe 70 is typically about 1 to 2 mm greater than the over-advancement depths of the other tools described herein, in order to ensure that distal end 79 of probe 70 reaches and pushes against membrane 144 (with sufficient vertical displacement of the membrane so as to enable a sensation of the elastic response of the membrane, indicating its integrity), regardless of any planning, design, and/or fabrication inaccuracies in surgical guide stent 124, as described hereinbelow with reference to FIGS. 13 and 14A-C.

For applications in which set 76 of dental probes 70 is provided, the surgeon selects the appropriate probe 70 from the set. This probe is the one which has an appropriate predefined distance, such that distal stopper surface 78 of proximal stopper 74 comes in contact with inferior surface 127 of surgical guide stent 124 at the same time as or soon after distal end 79 of probe 70 reaches Schneiderian membrane 144. Proximal stopper 74 thus prevents accidental excessive over-advancing into Schneiderian membrane 144, which would increase the risk of perforating the membrane. For some applications, the surgeon selects the appropriate probe 70 from the set responsively to a selection indication received from a provider of surgical guide stent 124, as described hereinbelow with reference to FIG. 15. For example, the selection indication may be a color, number, and/or letter marked on surgical guide stent 124 or provided on or in packaging in which surgical guide stent 124 is provided to the surgeon.

Alternatively, for some applications, shaft 73 of probe 70 is shaped so as to define a proximal shoulder, similar to proximal shoulder 108 of grinding drill 50, described hereinabove with reference to FIGS. 7A-B. Proximal stoppers 74 comprise a set of proximal stopper skirts that have respective, different longitudinal lengths, similar to proximal stopper skirts 110, described hereinabove with reference to FIGS. 7A-B. The surgeon selects the appropriate skirt from the set of skirts. This skirt is the one that has a distal stopper surface at an appropriate distance from distal end 79 of probe 70, similar to distance D13 described hereinabove with reference to FIGS. 7A-B. The surgeon passes the selected skirt over (a) distal end 79 of probe 70 and (b) shaft 73 of probe 70, until a proximal surface of the selected skirt abuts the proximal shoulder of shaft 73. For these applications, typically only a single probe 70 is provided.

Alternatively, for some applications, these probing techniques are used without surgical guide stent 124, in which case distal stopper surface 78 of proximal stopper 74 prevents excessive advancement of probe 70 by coming in contact with an occlusal surface of occlusal cortex 132 (if gingiva 122 is reflected) or gingiva 122 (if the gingiva is not reflected). For these applications, distance D14, described hereinabove with reference to FIG. 6, does not include a portion to provide for the thickness of surgical guide stent 124.

Reference is made to FIGS. 13 and 14A-C, which are schematic illustrations of techniques for advancing grinding drill 50 a desired distance through maxillary bone 120, in accordance with an application of the present invention. These techniques may also be used for advancing drill 40 and probe 70 a desired distance through maxillary bone 120, mutatis mutandis.

Although surgical guide stent 124 is useful for controlling the depth of advancement of grinding drill 50 and the other tools described herein (such as dental probe 70), the surgical guide stent may not always achieve the desired depth of insertion because of radioimaging, planning, design, fabrication, and/or placement and usage inaccuracies. Such inaccuracies may add up to +/−0.5-2 mm, which may be enough to either (a) puncture the Schneiderian membrane or (b) fail to traverse maxillary bone 120, either of which could cause partial or complete failure of the surgical procedure. In accordance with some applications of the present invention, in order to address these inaccuracies, surgical guide stent 124 is designed and fabricated to deliberately result in a slight planned over-advancement of grinding drill 50 and the other tools described herein (such as dental probe 70). As a result, if the inaccuracies cause unintended under-advancement, the distal end of the grinding drill (or other tool) still traverses the bone to the membrane. If the surgical stent guide is accurately manufactured as planned, or inaccuracies cause unintended over-advancement, the distal end of the grinding drill (or other tool) still does not damage the membrane because it is devoid of large cutting surfaces capable of perforating the membrane, and because the design limits the over-advancement to within a permissible extent that will not damage the membrane.

Reference is still made to FIG. 13. Distance D11 represents the margin of error, which, as mentioned above, is typically +/−0.5-2 mm. Distance D8 represents the height of maxillary bone 120, as measured during a radiographic imaging procedure. In FIG. 13, distance D8 includes the thickness of gingiva 122, for performance of a flapless procedure. The thickness of the gingiva may be measured by placing fiducial radiopaque markers against the gingiva, as is known in the dental arts. Alternatively, distance D8 does not include the thickness of the gingiva, for procedures in which the gingiva is reflected. Distance D9 represents the planned height of surgical guide stent 124 around hole 125. Thus, D12 represents the sum of (a) a distance D10 from inferior surface 127 of surgical guide stent 124 around hole 125 to the superior surface of maxillary bone 120 and (b) the margin of error (distance D11).

In accordance with an application of the present invention, surgical guide stent 124 is fabricated by setting the planned height of surgical guide stent 124 (distance D9) such that distance D12 equals the sum of (a) distance D8, (b) distance D9, and (c) the margin of error D11, with the constraint that distance D12 must be one of a set of predetermined distances. The predetermined distances correspond to the available distances between distal stopper surfaces 97 of proximal stoppers 54 of grinding drills 50 of set 56 provided to the surgeon, or the available distances of other tools described herein. As mentioned above with reference to FIG. 12, the desired over-advancement depth of probe 70 is typically about 1 to 2 mm greater than the over-advancement depths of the other tools described herein, in order to ensure that distal end 79 of probe 70 reaches and pushes against membrane 144 to an extent sufficient to generate a perceptible elastic response.

FIGS. 14A-C schematically show three exemplary possible scenarios, based on whether surgical guide stent 124 is fabricated inaccurately, and, if so, in which direction. FIG. 14A shows an exemplary scenario in which the overall distance from the bottom of surgical guide stent 124 to the top of maxillary bone 120 is greater than planned by distance D11. As a result, the surgeon underdrills by distance D11 compared to plan, but still traverses maxillary bone 120 and reaches the membrane, resulting in a successful sinus lift procedure. When a similar scenario occurs when using probe 70, the probe still reaches and pushes against membrane 144, because of the additional 1 to 2 mm of over-advancement depth that is provided.

FIGS. 14B shows an exemplary scenario in which the overall distance from the bottom of surgical guide stent 124 to the top of maxillary bone 120 is according to plan. As a result, the surgeon advances grinding drill 50 according to plan, resulting in overdrilling the superior surface of maxillary bone 120 by distance D11. Nevertheless, because of the non-perforating geometry of the distal end of the grinding drill, the membrane is not damaged. Similarly, over-advancing probe 70, even with the extra provided 1 to 2 mm of over-advancement depth, does not damage the membrane.

FIG. 14C shows an exemplary scenario in which the overall distance from the bottom of surgical guide stent 124 to the top of maxillary bone 120 is less than planned by distance D11. As a result, the surgeon overdrills by twice distance D11 compared to plan. Nevertheless, because of the non-perforating geometry of the distal end of the grinding drill, the membrane is not damaged. Similarly, over-advancing probe 70, even with the extra provided 1 to 2 mm of over-advancement depth, does not damage the membrane.

Reference is made to FIG. 15, which is a flowchart schematically illustrating a method for fabricating surgical guide stent 124, in accordance with an application of the present invention. This method is used to fabricate a custom surgical guide stent 124 for a patient for use with the techniques described herein, in accordance with the inventive principles described hereinabove with reference to FIGS. 13 and 14A-C. This method is typically performed by a provider of customer surgical stent guides. Surgical guide stent 124 is customized for each individual patient's alveolar bone, for example, such that the surgical guide stent fits the external contour of the gingiva, the bone, or the teeth. For some applications, surgical guide stent 124 comprises plastic.

The method begins at a model receipt step 200, at which the provider receives a three-dimensional virtual model of at least a maxillary alveolar bone 120 of a patient. The virtual model optionally further includes gingiva 122 and/or nearby teeth. At a dental implant plan receipt step 202, the provider receives at least one digital dental implant plan that defines a planned dental implant site of the maxillary bone 120. At a value set receipt step 204, the provider receives a set of values consisting of between two and eight predefined distances. These correspond to the available distances between the stoppers and the distal ends of the tools available in the set of tools available to the surgeon, as described above. Steps 200, 202, and 204 may be performed in any order, or simultaneously. For some applications, receiving the three-dimensional virtual model of the maxillary bone comprises receiving a three-dimensional radiographic image (e.g., a CT image) of the maxillary bone, and converting the three-dimensional radiographic image to the three-dimensional virtual model of the maxillary bone.

As a virtual modeling step 206, the provider creates a virtual model of a surgical guide stent 124 for placement against an occlusal surface selected from the group consisting of: an occlusal surface of the maxillary bone 120 of the patient, an occlusal surface of gingiva 122 covering the maxillary bone, and an occlusal surface of teeth near the planned dental implant site. The virtual model of the surgical guide stent defines:
a hole 125 through surgical guide stent 124 at a site corresponding to the planned dental implant site defined in the digital dental implant plan, and
an inferior surface 127 surrounding hole 125, such that one of the predefined distances of the set equals a sum of (a) a modeled distance between the inferior surface and a superior surface of the maxillary bone and (b) an over-advancement depth equal to between 0.1 and 5 mm. The inferior surface may be defined by material integral to the rest of the surgical guide stent, or by other elements coupled to the main material of the surgical stent guide, such as by a metal cylinder that protrudes from the rest of the surgical stent guide, in which case the inferior end of the cylinder defines the inferior surface.

For some applications in which surgical guide stent 124 is planned to be used with grinding drills 50, the over-advancement depth typically equals between 0.1 and 4 mm, such as between 0.2 and 2.5 mm, e.g., between 0.5 and 1.5 mm. For some applications in which surgical guide stent 124 is planned to be used with dental probes 70, the over-advancement depth typically equals between 1 and 5 mm.

At an output step 208, the provider outputs the virtual model of the surgical guide stent in association with the one of the predefined distances.

Steps 200 through 208 are typically performed by a human using software running on a computer system. Alternatively, the steps are performed entirely by the software running on the computer system.

At a fabrication step 210, the surgical guide stent is fabricated based on the virtual model of the surgical guide stent. The fabrication may be performed by the same entity that performs steps 200 through 208, or by another entity. The fabrication is typically performed using custom fabrication techniques known in the art.

At an indication step 212, the provider provides an indication of the one of the predefined distances. For example, the indication may be a color, number, and/or letter marked on surgical guide stent 124 or provided on or in packaging in which surgical guide stent 124 is provided to the surgeon. The surgeon uses the indication to select the appropriate tool from a set of tools to use with the surgical guide stent in the procedure. The appropriate tool is typically marked with a corresponding indication, such as the same color, number, and/or letter.

Reference is made to FIG. 16, which is a schematic illustration of surgical guide stent 124 applied to an occlusal surface 300 of teeth 302 near (e.g., adjacent) a planned dental implant site 304 of maxillary bone 120, in accordance with an application of the present invention. This configuration of surgical guide stent 124 may be used with any of the techniques described herein.

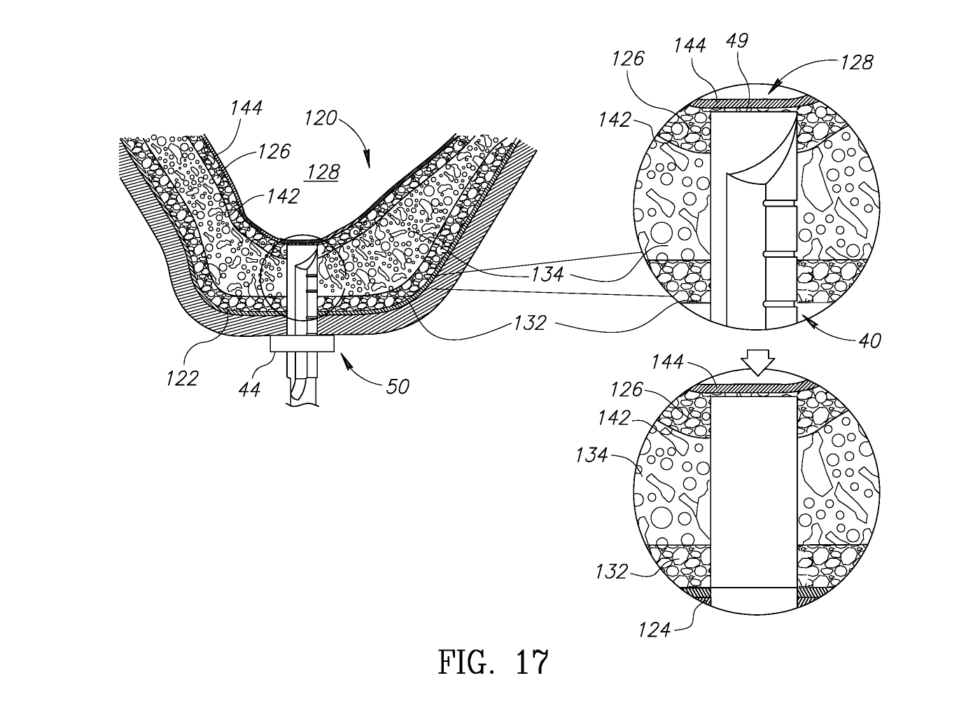

Reference is made to FIG. 17, which is a schematic illustration of a step of a minimally-invasive stent-assisted closed sinus lift surgical procedure, in accordance with an application of the present invention. This step is optionally performed instead of the step of the procedure described hereinabove with reference to FIG. 9D. The surgeon ceases advancing drill 40 before distal end 49 penetrates superior cortex 126, such as a predetermined distance (e.g., 1 mm) below the superior surface of the superior cortex. In order to achieve this desired depth of advancement of drill 40, the surgeon typically ceases advancing drill 40 when distal stopper surface 48 of proximal stopper 44 of drill 40 comes in contact with inferior surface 127 surrounding hole 125 of surgical guide stent 124.

Generally, upon the conclusion of this step of the procedure, a residual portion 146 of superior cortex 126 remains between distal end 49 and Schneiderian membrane 144. Residual portion 146 typically has a thickness of no more than 3 mm, such as no more than 1 mm. The superior cortex is weakened sufficiently to enable a dental implement to readily break through the remaining portion of the superior cortex. The surgeon cuts through (e.g., cracks through) the superior cortex, using a dental implement other than drill 40. For some applications, the dental implement is a dental implant 150, the insertion of which is described hereinabove with reference to FIG. 9F. Alternatively, a tool, such as an osteotome (e.g., a rotational osteotome) is used to cut (e.g., crack) through. For example, osteotome 302, described hereinabove with reference to FIGS. 10 and 11A-B, may be used.

As used herein, including in the claims, the “distal” end of the implant is the end that is inserted first into a bone, such as an alveolar bone, and is sometimes referred to in the art as the apical end, and the “proximal” end of the implant is the end of the implant opposite the distal end, e.g., that faces the oral cavity, and is sometimes referred to in the art as the coronal end. Similarly, “distal” means situated toward the distal end of the implant, and “proximal” means situated toward the proximal end of the implant.

The scope of the present invention includes embodiments described in the following patent applications, which are assigned to the assignee of the present application and are incorporated herein by reference. In an embodiment, techniques and apparatus described in one or more of the following applications are combined with techniques and apparatus described herein:
U.S. application Ser. No. 12/240,353, filed Sep. 29, 2008, which issued as U.S. Pat. No. 7,934,929;
U.S. application Ser. No. 12/485,199, filed Jun. 16, 2009, which issued as U.S. Pat. No. 8,029,284;
International Application PCT/IL2009/000931, filed Sep. 29, 2009, which published as PCT Publication WO 2010/035270;
International Application PCT/IL2010/000252, filed Mar. 24, 2010, which published as PCT Publication WO 2010/146573;
U.S. application Ser. No. 12/661,795, filed Mar. 24, 2010, which issued as U.S. Pat. No. 8,388,343;
U.S. application Ser. No. 13/314,818, filed Dec. 8, 2011, which published as US Patent Application Publication 2012/0094254; and/or
U.S. application Ser. No. 13/314,740, filed Dec. 8, 2011, entitled, “Cortical drilling,” which issued as U.S. Pat. No. 8,702,423.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A method comprising:
receiving (a) a three-dimensional virtual model of at least a maxillary alveolar bone of a patient, and (b) at least one digital dental implant plan that defines a planned dental implant site of the maxillary bone;
receiving a set of values consisting of between two and eight predefined distances;
creating a virtual model of a surgical guide stent for placement against an occlusal surface selected from the group consisting of: an occlusal surface of the maxillary bone of the patient, an occlusal surface of gingiva covering the maxillary bone, and an occlusal surface of teeth near the planned dental implant site, wherein the virtual model of the surgical guide stent defines:
a hole through the surgical guide stent at a site corresponding to the planned dental implant site defined in the digital dental implant plan, and
an inferior surface surrounding the hole, such that one of the predefined distances of the set equals a sum of (a) a modeled distance between the inferior surface and a superior surface of the maxillary bone and (b) an over-advancement depth equal to between 0.1 and 5mm; and
outputting the virtual model of the surgical guide stent in association with the one of the predefined distances.

2. The method according to claim 1, further comprising fabricating the surgical guide stent based on the virtual model of the surgical guide stent.

3. The method according to claim 2, further comprising:
placing the fabricated surgical guide stent against the selected occlusal surface;
inserting, through the hole of the surgical guide stent, a distal end of a dental grinding drill, which dental grinding drill is shaped so as to define (a) a distal grinding surface and (b) a shaft that has a proximal stopper having a distal stopper surface at the one of the predefined distances from the distal end of the dental grinding drill; and
lengthening a bore through the maxillary bone using the dental grinding drill, by advancing the dental grinding drill through the maxillary bone until the distal stopper surface of the proximal stopper of the dental grinding drill comes in contact with the inferior surface surrounding the hole of the surgical guide stent.

4. A method comprising:
receiving a virtual model of a surgical guide stent; and
based on the virtual model of the surgical guide stent, fabricating the surgical guide stent for placement against an occlusal surface selected from the group consisting of: an occlusal surface of a maxillary bone of a patient, an occlusal surface of gingiva covering the maxillary bone, and an occlusal surface of teeth near a planned dental implant site of the maxillary bone, which surgical guide stent is shaped so as to define (a) a hole therethrough at a site corresponding to the planned dental implant site, (b) an inferior surface surrounding the hole, wherein one of a set of predefined distances consisting of between two and eight predefined distances equals a sum of (a) a modeled distance between the inferior surface and a superior surface of the maxillary bone and (b) an over-advancement depth equal to between 0.1 and 5 mm.

5-10. (canceled)

11. A method comprising:
placing a surgical guide stent against an occlusal surface selected from the group consisting of: an occlusal surface of a maxillary alveolar bone of a patient, an occlusal surface of gingiva covering the maxillary bone, and an occlusal surface of teeth near a planned dental implant site of the maxillary bone, which surgical guide stent is shaped so as to define (a) a hole therethrough at a site corresponding to the planned dental implant site, and (b) an inferior surface surrounding the hole;
forming an osteotomy through the maxillary bone;
inserting, through the hole of the surgical guide stent, a distal end of a dental probe, which dental probe is shaped so as to define (a) a blunt distal end and (b) a shaft that has a proximal stopper having a distal stopper surface at a predefined distance from the distal end, which predefined distance equals a sum of (i) a distance between the inferior surface surrounding the hole and a superior surface of the maxillary bone of the patient and (ii) an over-advancement depth equal to between 1 and 5 mm;
advancing the dental probe through the maxillary bone until the distal end comes in contact with a Schneiderian membrane; and
sensing elasticity of the Schneiderian membrane using the dental probe.

12. The method according to claim 11, further comprising ceasing advancing if the distal stopper surface of the dental probe comes in contact with the inferior surface surrounding the hole of the surgical guide stent.

13-20. (canceled)

21. The method according to claim 11, wherein the dental probe includes a plurality of visually-sensible fiducial designators distributed along the shaft thereof, and wherein advancing comprising measuring a depth of insertion of the dental probe in the maxillary bone using the visually-sensible fiducial designators.

22. The method according to claim 11,
wherein the dental probe is a member of a set of dental probes, which are shaped so as to define (a) respective blunt distal ends, and (b) respective shafts that are shaped so as to define respective proximal stoppers having respective distal stopper surfaces at respective, different predefined distances from respective distal ends of the dental probes, and
wherein inserting comprises selecting the dental probe from the set of dental probes.

23. The method according to claim 22, wherein the set of dental probes consists of between two and eight dental probes, and wherein selecting comprises selecting the dental probe from the set of dental probes consisting of between two and eight dental probes.

24. The method according to claim 22, wherein selecting the dental probe comprises selecting the dental probe responsively to a selection indication received from a provider of the surgical guide stent.

25. The method according to claim 11,
wherein the shaft is shaped so as to define a proximal shoulder,
wherein the distal stopper surface is one of a plurality of distal stopper surfaces,
wherein the proximal stopper includes a set of proximal stopper skirts, which are shaped so as to define (a) respective ones of the distal stopper surfaces and (b) respective longitudinal bores through the skirts that are shaped and sized to be passable over (i) the distal end of the dental probe and (ii) the shaft, until proximal surfaces of the proximal stopper skirts abut the proximal shoulder of the shaft, such that the distal stopper surfaces are at predefined, different distances from the distal end of the dental probe, and
wherein the method further comprises, before inserting the dental probe through the hole, passing one of the proximal stopper skirt over (a) the distal end of the dental probe and (b) the shaft, until the proximal surface of the proximal stopper skirt abuts the proximal shoulder of the shaft.

26. The method according to claim 25, wherein the set of proximal stopper skirts consists of between two and eight proximal stopper skirts.

27. The method according to claim 25, wherein passing the one of the proximal stopper skirts comprises selecting the one of the proximal stopper skirts responsively to a selection indication received from a provider of the surgical guide stent.

28. The method according to claim 1, further comprising providing an indication of the one of the predefined distances.

29. The method according to claim 1, wherein receiving the three-dimensional virtual model of at least the maxillary bone comprises receiving a three-dimensional radiographic image of the maxillary bone, and converting the three-dimensional radiographic image to the three-dimensional virtual model of at least the maxillary bone.

30. The method according to claim 4, further comprising providing an indication of the one of the predefined distances in association with the surgical guide stent.
